(19) United States
(12) Patent Application Publication
(10) Pub. No.: US 2013/0343300 A1
(43) Pub. Date: Dec. 26, 2013

(54) METHOD AND APPARATUS FOR TRANSMITTING AND RECEIVING DATA

(71) Applicant: LG Electronics Inc., Seoul (KR)

(72) Inventors: Bong Hoe KIM, Anyang-si (KR); Han Byul SEO, Anyang-si (KR); Ki Jun KIM, Anyang-si (KR)

(21) Appl. No.: 13/923,042

(22) Filed: Jun. 20, 2013

Related U.S. Application Data
(60) Provisional application No. 61/662,369, filed on Jun. 21, 2012.
(60) Provisional application No. 61/684,151, filed on Aug. 17, 2012.

(51) Int. Cl. H04W 72/04

(52) U.S. Cl. CPC H04W 72/048
USPC 370/329

(57) ABSTRACT

A method and apparatus of transmitting and receiving data is provided. A method of a channel state information (CSI) feedback of a mobile terminal comprises receiving, by the mobile terminal, a CSI feedback configuration configuring a CSI feedback reporting to a base station without precoding matrix index (PMI) and rank index (RI), receiving, by the mobile terminal, a CSI configuration for a channel state information reference signal (CSI-RS), determining, by the mobile terminal, a physical downlink share channel (PDSCH) transmission scheme based on an antenna port of the CSI-RS, determining, by the mobile terminal, a CSI based on the PDSCH transmission scheme and transmitting, by the mobile terminal, the CSI to the base station.

### CROSS-REFERENCE TO RELATED APPLICATIONS

This application claims the benefit of priority of U.S. Provisional applications 61/662,369 filed on Jun. 21, 2012, and 61/684,151 filed on Aug. 17, 2012, all of which are incorporated by reference in their entirety herein.

### BACKGROUND OF THE INVENTION

1. Field of the Invention

The present invention relates to wireless communication and, more particularly, to a method and apparatus for transmitting and receiving data.

2. Related Art

In a Long Term Evolution (LTE) release 12, researches are focused on improving performance in terms of capacity, coverage, coordination between cells, and expenses. In the LTE release 12, for this performance improvement, the introduction of various types of techniques, such as small cell enhancement, macro cell enhancement, a new carrier type, and machine type communication, are being discussed in a technical aspect.

The improvement of the capacity and coverage, that is, the target of the LTE release 12, can be achieved by small cell enhancement based on an inter-site carrier aggregation, integration between LTE-Wireless Local Area Networks (WLANs), and macro cell enhancement. Assuming that the size of a cell is reduced, the amount of traffic signaled when UE moves can be increased because the UE frequently moves between cells. In order to solve this problem, in the LTE release 12, a method of optimizing a small cell by reducing signaling transmitted from a Radio Access Network (RAN) to a core network based on small cell enhancement is being discussed.

Furthermore, a New Carrier Type (NCT) being discussed in the LTE release 12 is a frame type that is newly and differently defined from the construction of a legacy frame. The NCT can be a carrier type optimized for a small cell, but may also be applied to a macro cell. For example, in the NCT, overhead generated due to the transmission of a reference signal, such as a Cell-specific Reference Signal (CRS), can be reduced and a downlink control channel can be demodulated based on a demodulation reference signal (DM-RS). By newly defining the NCT, the energy of a base station can be reduced and interference occurring in a heterogeneous network (HetNet) can be reduced. Furthermore, a reference signal overhead occurring when data is transmitted using a plurality of downlink antennas can be reduced by using the NCT. More particularly, the NCT maintains an existing frame structure (e.g., the length of a CP, a subframe structure, and duplexing mode), but a control channel and/or a reference signal can be newly defined.

### SUMMARY OF THE INVENTION

An object of the present invention is to provide a method of transmitting and receiving data.

Another object of the present invention is to provide an apparatus for transmitting and receiving data.

### BRIEF DESCRIPTION OF THE DRAWINGS

FIG. 1 shows the structure of a radio frame in 3rd Generation Partnership Project) Long Term Evolution (LTE);

FIG. 2 shows an example of a resource grid for a downlink slot;

FIG. 3 shows the structure of a downlink subframe;

FIG. 4 shows the structure of an uplink subframe;

FIG. 5 is a block diagram showing a method of generating PDCCH data;

FIG. 6 is an exemplary diagram showing the monitoring of a PDCCH;

FIG. 7 shows an example in which reference signals and control channels are arranged in a downlink subframe of 3GPP LTE;

FIG. 8 shows an example of a subframe having EPDCCHs;

FIG. 9 is a conceptual diagram showing carrier aggregations;

FIG. 10 is a conceptual diagram showing PCells and SCells;

FIG. 11 is a conceptual diagram showing a method of transmitting data to UE based on a Coordinated Multi-Point (CoMP) in plurality of TPs;

FIG. 12 shows the transmission of a synchronization signal and PBCH data in a legacy subframe when Frequency Division Duplexing (FDD) is used in according to a duplexing method;

FIG. 13 is a conceptual diagram showing the transmission of a CSI-RS and the feedback of CSI measured by UE in accordance with an embodiment of the present invention;

FIG. 14 is a conceptual diagram showing the configuration of CSI-RSs in an RB pair depending on the number of CSI-RSs in accordance with an embodiment of the present invention;

FIG. 15 is a conceptual diagram showing a method of performing CSI feedback based on signals transmitted by a plurality of TPs in accordance with an embodiment of the present invention;

FIG. 16 is a conceptual diagram illustrating a case where a plurality of downlink TPs performs a CoMP based on a legacy subframe in accordance with an embodiment of the present invention;

FIG. 17 is a conceptual diagram showing a case where a plurality of downlink TPs performs a CoMP based on a legacy subframe and an NCT subframe in accordance with an embodiment of the present invention;

FIG. 18 is a conceptual diagram showing a case where a plurality of downlink TPs performs a CoMP based on an NCT subframe in accordance with an embodiment of the present invention; and

FIG. 19 is a block diagram showing a wireless communication system in accordance with an embodiment of the present invention.

### DESCRIPTION OF EXEMPLARY EMBODIMENTS

A wireless device can be fixed or mobile and can also be called another term, such as User Equipment (UE), a Mobile Station (MS), a Mobile Terminal (MT), a User Terminal (UT), a Subscriber Station (SS), a Personal Digital Assistant (PDA), a wireless modem, a handheld device, a terminal, or a wireless terminal. Furthermore, the wireless device can be a device supporting only data communication, such as a Machine-Type Communication (MTC) device.

A Base Station (BS) commonly refers to a fixed station communicating with a wireless device, and the BS can also be called another term, such as an evolved-NodeB (eNB), a Base Transceiver System (BTS), or an access point.

Hereinafter, in 3GPP Long Term Evolution (LTE) or 3GPP LTE-A defined based on the releases of 3rd Generation Partnership Project) Technical Specification (TS), the operations of UE and/or a BS are disclosed. Furthermore, the present invention may also be applied to various types of wireless communication networks other than 3GPP LTE/3GPP LTE-A. Hereinafter, LTE includes LTE and/or LTE-A.

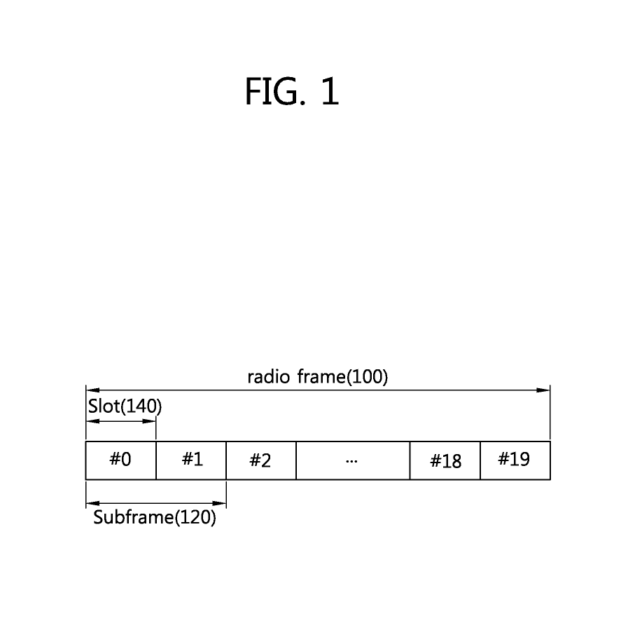

FIG. 1 shows the structure of a radio frame in LTE.

In 3GPP LTE, the structure of a radio frame 100 is disclosed in Paragraph 5 of 3GPP TS 36.211 V8.2.0 (2008-03) “Technical Specification Group Radio Access Network; Evolved Universal Terrestrial Radio Access (E-UTRA); Physical channels and modulation (Release 8)”.

Referring to FIG. 1, the radio frame 100 consists of 10 subframes 120. One subframe 120 consists of two slots 140. The radio frame 100 can be indexed from a slot #0 to a slot #19 on the basis of the slot 140 or can be indexed from a subframe #0 to a subframe #9 on the basis of a subframe according to the subframe 120. For example, the subframe #0 can include the slot #0 and the slot #1.

The time taken to send one subframe 120 is called a Transmission Time Interval (TTI). The TTI can be a scheduling unit for data transmission. For example, the length of one radio frame 100 can be 10 ms, the length of one subframe 120 can be 1 ms, and the length of one slot 140 can be 0.5 ms.

One slot 140 includes a plurality of Orthogonal Frequency Division Multiplexing (OFDM) symbols in a time domain and includes a plurality of subcarriers in a frequency domain. In LTE, a BS uses OFDMA as an access method in a downlink channel. The OFDM symbol is for representing one symbol period and can be called another term depending on a multiple access method. For example, in an uplink channel through which UE sends data to a BS, Single Carrier-Frequency Division Multiple Access (SC-FDMA) can be used as a multiple access method. A symbol period during which data is transmitted through an uplink channel can be called an SC-FDMA symbol.

The structure of the radio frame 100 disclosed in FIG. 1 is one embodiment of a frame structure. Accordingly, a new radio frame format can be defined by changing the number of subframes 120 included in the radio frame 100, the number of slots 140 included in the subframe 120, or the number of OFDM symbols included in the slot 140 in various ways.

In the structure of a radio frame, the number of symbols included in one slot can vary depending on what Cyclic Prefix (CP) is used. For example, if a radio frame uses a normal CP, one slot can include 7 OFDM symbols. If a radio frame uses an extended CP, one slot can include 6 OFDM symbols.

A wireless communication system can use a Frequency Division Duplexing (FDD) method and a Time Division Duplexing (TDD) method in according to a duplexing method. In accordance with the FDD method, uplink transmission and downlink transmission can be performed based on different frequency bands. In accordance with the TDD method, uplink transmission and downlink transmission can be performed using a partition method based on the time based on the same frequency band. A channel response in the TDD method can have a reciprocal character because the same frequency band is used. That is, in the TDD method, a downlink channel response can be almost the same as an uplink channel response in a given frequency region. Accordingly, a wireless communication system based on the TDD method can obtain Channel State Information (CSI) about a downlink channel from CSI about an uplink channel. In the TDD method, the downlink transmission of a BS and the uplink transmission of UE cannot be performed at the same time because the entire frequency band is subject to time division into uplink transmission and downlink transmission.

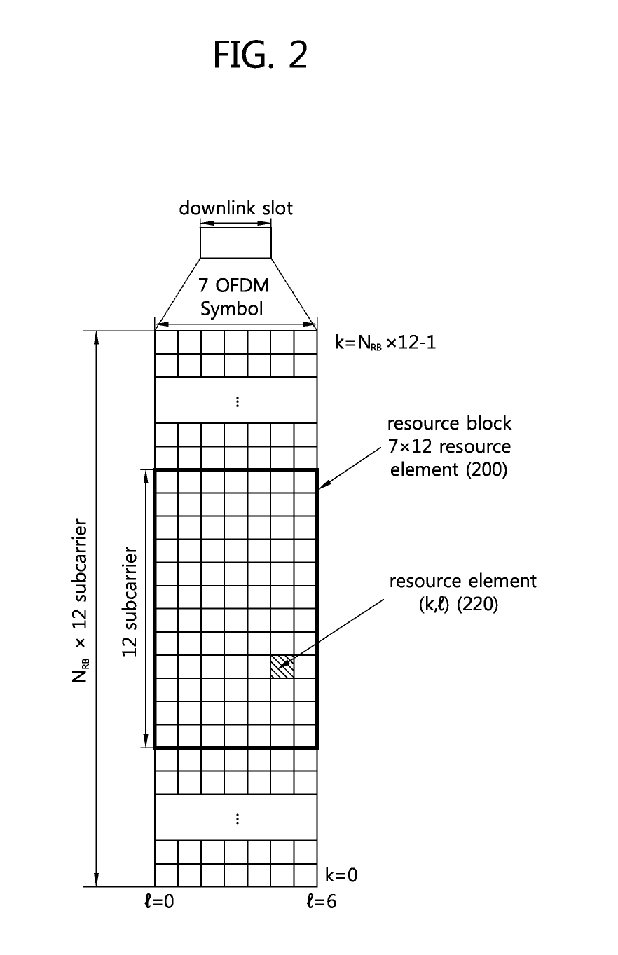

FIG. 2 shows an example of a resource grid for a downlink slot.

The downlink slot includes a plurality of OFDM symbols in a time domain and includes an NRB number of Resource Blocks (RBs) in a frequency domain. The number of RBs NRB included in the downlink slot can be determined by a downlink transmission bandwidth configured in a cell. For example, in an LTE system, the number of RBs NRB may be any one of 60 to 110 depending on a transmission bandwidth used. One RB 200 can include a plurality of subcarriers in a frequency domain. An uplink slot can have the same structure as the downlink slot.

Each element on the resource grid is referred to as a Resource Element (RE) 220. The RE 220 on the resource grid can be identified by (k,l), that is, an index pair. Here, k(k=0, . . . , NRB×12-1) is an index of a subcarrier in the frequency domain, and l(l=0, . . . , 6) is an index of an OFDM symbol in the time domain.

In FIG. 2, one RB 200 can include 7×12 REs 220, including 7 OFDM symbols in the time domain and 12 subcarriers in the frequency domain. This size is only an example, and the number of OFDM symbols and the number of subcarriers forming one RB 200 can be changed. The RB pair indicates a resource unit including two RBs.

The number of OFDM symbols included in one slot can have a different value depending on a CP as described above CP. Furthermore, the number of RBs included in one slot can be changed depending on the total size of a frequency bandwidth.

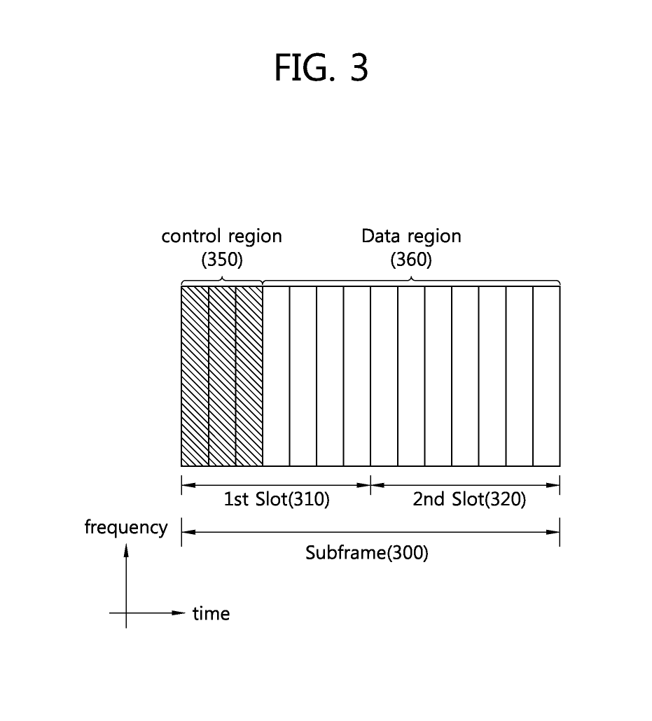

FIG. 3 shows the structure of a downlink subframe.

The downlink subframe 300 can be divided into two slots 310 and 320 on the basis of the time. Each of the slots 310 and 320 includes 7 OFDM symbols in a normal CP. A resource region corresponding to a maximum of temporally former 3 OFDM symbols (i.e., a maximum of 4 OFDM symbols for a 1.4 MHz bandwidth) in the first slot 310 of the downlink subframe 300 can be used as a control region 350 to which control channels are allocated. The remaining OFDM symbols can be used as a data region 360 to which traffic channels, such as physical downlink shared channels (PDSCHs), are allocated.

A PDCCH can be, for example, a control channel on which the resource allocation and transport format of a downlink-shared channel (DL-SCH), information about the resource allocation of an uplink shared channel (UL-SCH), information about paging on a PCH, system information on a DL-SCH, the resource allocation of a higher layer control message, such as a random access response transmitted on a PDSCH, a set of transmit power control commands for each MS within a specific UE group, and information about the activation of a Voice Over Internet Protocol (VoIP). A plurality of units on which PDCCH data is transmitted can be defined within the control region 350. UE can obtain control data by monitoring the plurality of units on which the PDCCH data is transmitted. For example, the PDCCH data can be transmitted to UE based on an aggregation of one or several consecutive Control Channel Elements (CCEs). The CCE can be one unit on which PDCCH data is transmitted. The CCE can include a plurality of RE groups. The RE group is a resource unit including 4 available REs.

A BS determines a PDCCH format based on Downlink Control Information (DCI) to be transmitted to UE and attaches a Cyclic Redundancy Check (CRC) to the DCI. A unique identifier (i.e., Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) can be masked to the CRC. If the PDCCH is a PDCCH for a paging message, a paging instruction identifier, for example, a Paging-RNTI (P-RNTI) can be masked to the CRC. If the PDCCH is a PDCCH for a System Information Block (SIB), a system information identifier, for example, a System Information-RNTI (SI-RNTI) can be masked to the CRC. A Random Access-RNTI (RA-RNTI) can be masked to the CRC in order to indicate a random access response, that is, a response to the transmission of a random access preamble by UE.

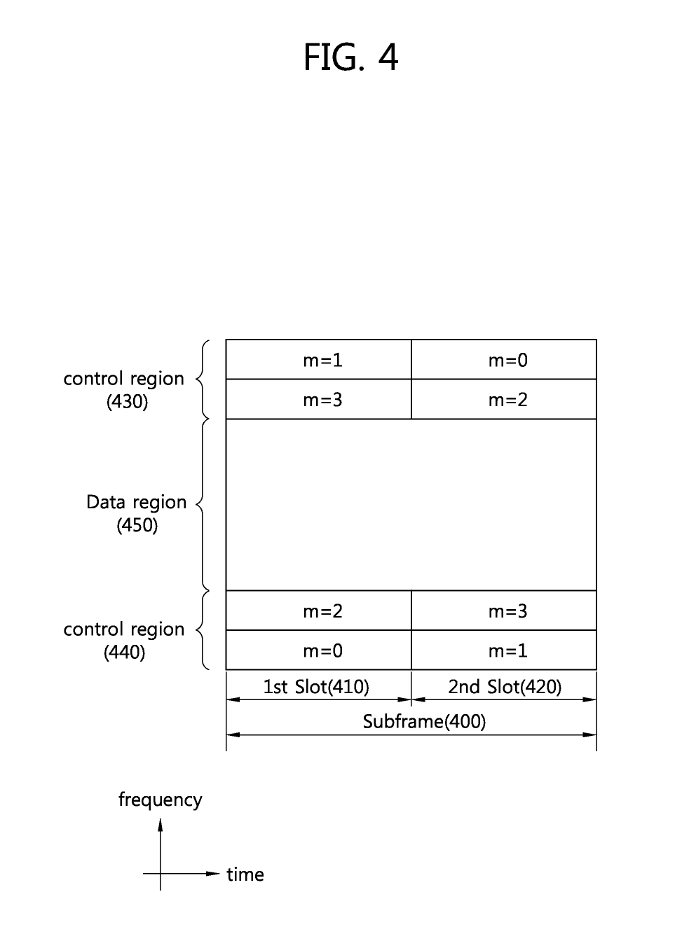

FIG. 4 shows the structure of an uplink subframe.

The uplink subframe 400 can be divided into control regions 430 and 440 and a data region 450 on the basis of a frequency domain. Physical uplink control channels (PUCCHs) on which uplink control information is transmitted are allocated to the control regions 430 and 440. Physical uplink shared channels (PUSCHs) on which data is transmitted are allocated to the data region 450. If an instruction is given by a higher layer, UE can support the simultaneous transmission of a PUSCH and a PUCCH.

A PUCCH for one MS can be allocated to each Resource Block (RB) pair in the subframe 400. Resource blocks belonging to the RB pair can be allocated to different subcarriers in a first slot 410 and a second slot 420. A frequency occupied by RBs belonging to an RB pair allocated to a PUCCH is changed on the basis of a slot boundary. This PUCCH allocation method is called a frequency-hopped method. UE can obtain a frequency diversity gain by sending uplink control information through different subcarriers over time. In FIG. 4, ‘m’ is a position index indicative of the logical frequency domain position of an RB pair allocated to a PUCCH in the subframe.

Uplink control information transmitted on a PUCCH can include Hybrid Automatic Repeat reQuest (HARQ) acknowledgement (ACK)/non-acknowledgement (NACK), a Channel Quality Indicator (CQI) indicative of a downlink channel state, a Scheduling Request (SR), that is, an uplink radio resource allocation request, etc.

A PUSCH is a channel mapped to an uplink shared channel (UP-SCH), that is, a transport channel. Uplink data transmitted on a PUSCH can be a transport block, that is, the data block of an UL-SCH transmitted during a TTI. The transport block includes user information. Furthermore, uplink data may be multiplexed data. The multiplexed data is data in which a transport block for an UL-SCH and control information are multiplexed. For example, control information multiplexed with data can include a CQI, a Precoding Matrix Indicator (PMI), an HARQ, and a Rank Indicator (RI). Or, the uplink data may include only control information.

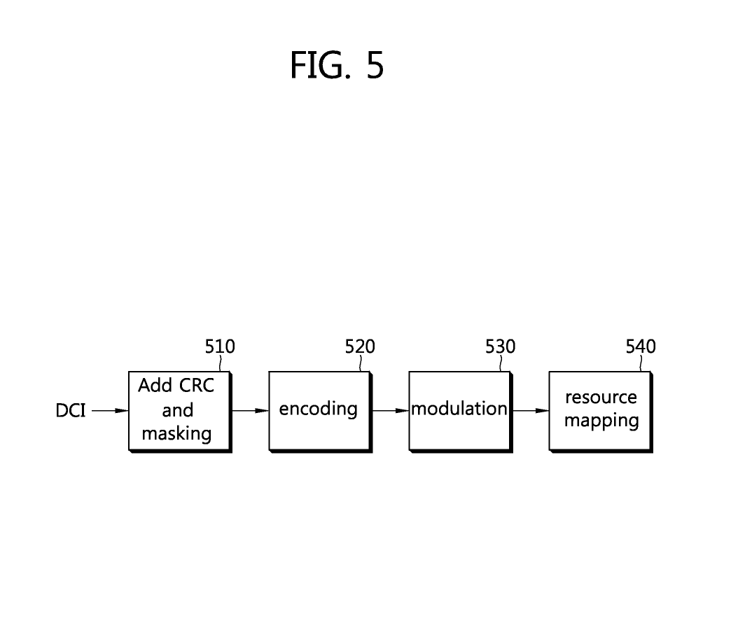

FIG. 5 is a block diagram showing a method of generating PDCCH data.

FIG. 5 discloses a detailed method of generating PDCCH data.

UE performs blind decoding in order to detect a PDCCH. The blind decoding can be performed based on an identifier masked to the CRC of a received PDCCH (this is called a candidate PDCCH). The UE can check whether received PDCCH data is its own control data or not by checking a CRC error in the received PDCCH data.

A BS determines a PDCCH format based on Downlink Control Information (DCI) to be transmitted to UE, attaches a Cyclic Redundancy Check (CRC) to the DCI, and masks a unique identifier (this is called a Radio Network Temporary Identifier (RNTI)) according to the owner or use of a PDCCH to the CRC (block 510).

If the PDCCH is a PDCCH for specific UE, an identifier unique to the UE, for example, a Cell-RNTI (C-RNTI) can be masked to the CRC. If the PDCCH is a PDCCH for a paging message, a paging instruction identifier, for example, a Paging-RNTI (P-RNTI) can be masked to the CRC. If the PDCCH is a PDCCH for system information, a system information identifier, for example, a System Information-RNTI (SI-RNTI) can be masked to the CRC. Furthermore, a BS can mask a Random Access-RNTI (RA-RNTI) to the CRC in order to indicate a random access response, that is, a response to the transmission of a random access preamble, and can mask a Transmit Power Control (TPC)-RNTI to the CRC in order to indicate a TPC command for a plurality of MSs.

A PDCCH masked with a C-RNTI can send control information for specific UE (this is called UE-specific control information), and a PDCCH masked with another RNTI can send common control information that is received by all MSs within a cell or a plurality of MSs within the cells. In order to send the PDCCH data, a plurality of DCI formats can be defined. This is described later.

The BS generates encoded data by encoding the DCI to which the CRC has been added (block 520). The encoding includes channel encoding and rate matching.

The BS generates modulation symbols by performing modulation on the encoded data (block 530).

The BS maps the modulation symbols to a physical Resource Element (RE) (block 540). The BS can map the modulation symbols to each RE.

As described above, a control region within a subframe includes a plurality of Control Channel Elements (CCEs). The CCE is a logical allocation unit used to provide a PDCCH with a coding rate depending on the state of a radio channel, and the CCE corresponds to a plurality of Resource Element Groups (REGs). The REG includes a plurality of REs. One REG includes 4 REs, and one CCE includes 9 REGs. In order to configure one PDCCH, 1, 2, 4, or 8 CCEs can be used. An aggregation of 1, 2, 4, or 8 CCEs is called a CCE aggregation level.

The BS can determine the number of CCEs used to send the PDDCH depending on a channel state. For example, when a downlink channel state is good, the BS can use a single CCE in order to send the PDCCH data to the UE. When a downlink channel state is poor, however, the BS can use 8 CCEs in order to send the PDCCH data to the UE.

A control channel consisting of one or more CCEs can be subject to the interleaving of an REG unit, subject to a cyclic shift based on a cell identifier (ID), and then mapped to physical resources.

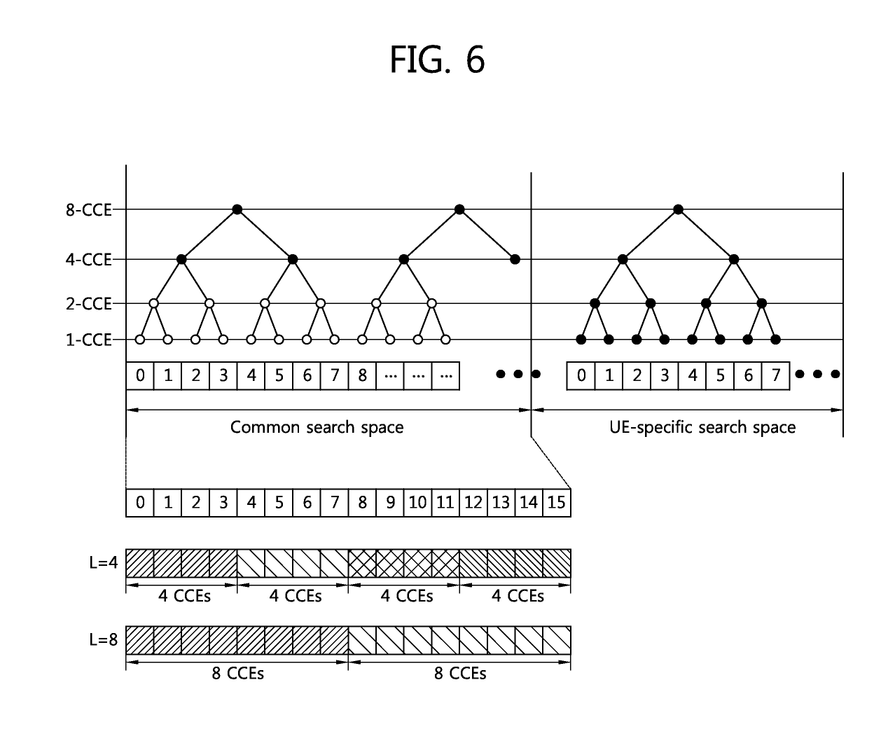

FIG. 6 is an exemplary diagram showing the monitoring of a PDCCH. For the monitoring of a PDCCH, reference can be made to Paragraph 9 of 3GPP TS 36.213 V10.2.0 (2011-06).

UE can perform blind decoding in order to detect a PDCCH. Blind decoding is a method of demasking the CRC of received PDCCH (this is called a PDCCH candidate) data based on a specific identifier and then checking whether a corresponding PDCCH is its own control channel or not by checking a CRC error. The UE is unaware that its own PDCCH data is transmitted at which position within a control region and that the PDCCH data is transmitted using what CCE aggregation level and DCI format.

A plurality of PDCCHs can be transmitted within one subframe. The UE monitors a plurality of PDCCHs every subframe. Here, the monitoring means that the UE attempts blind decoding on the PDCCHs.

In 3GPP LTE, UE uses a search space in order to reduce a burden due to the execution of blind decoding. The search space can be said to be a monitoring set of CCEs for searching for a PDCCH. The UE can monitor PDCCHs based on the search space.

The search space is divided into a common search space and a UE-specific search space. The common search space is a space where a PDCCH having common control information is searched for. The common search space includes 16 CCEs having CCE indices 0-15 and supports a PDCCH having a CCE aggregation level of {4, 8}. However, PDCCH data (DCI format 0, 1A) that carries UE-specific information may also be transmitted in the common search space. The UE-specific search space supports a PDCCH having a CCE aggregation level of {1, 2, 4, 8}.

Table 1 below shows the number of PDCCH candidates monitored by UE.

TABLE 1

| Search space | Aggregation | Size | Number of PDCCH | DCI |
|---|---|---|---|---|
| Sₖ^{(L)} Type | level L | [in CCEs] | candidates M^{(L)} | format |
| UE- | 1 | 6 | 6 | 0, 1, 1A, |
| specific | 2 | 12 | 6 | 1B, 1D, |
| | 4 | 8 | 2 | 2, 2A |
| | 8 | 16 | 2 | |
| Common | 4 | 16 | 4 | 0, 1A, 1C, |
| | | | | 3/3A |

The size of a search space is defined by Table 1, and the start point of the search space is differently defined in the common search space and the UE-specific search space. A start point of the common search space is fixed irrespective of a subframe, whereas a start point of the UE-specific search space can vary in each subframe depending on a UE identifier (e.g., C-RNTI), a CCE aggregation level and/or a slot number within a radio frame. If a start point of the UE-specific search space is within the common search space, the UE-specific search space and the common search space may overlap with each other.

An aggregation of PDCCH candidates monitored by UE can be defined based on a search space. In an aggregation level 1, 2, 4, or 8, a search space Sₖ^{(L)} is defined as an aggregation of PDCCH candidates. In the search space Sₖ^{(L)}, a CCE corresponding to a PDCCH candidate ‘m’ is given as in Equation 1 below.

L·{Yₖ+m′)mod └N_{CCE,k}/L┘}+i <Equation 1>

In Equation 1, i=0, . . . , L−1. If the search space is a common search space, m′=m. In the case where the search space is a UE-specific search space, when a Carrier Indicator Field (CIF) is configured in UE, m′=m+M^{(L)}·n_{CI} and n_{CI} is a value of the configured CIF. If a CIF is not configured in the UE, m′=m. Here, m=0, . . . , M^{(L)}−1, and M^{(L)} is the number of PDCCH candidates for monitoring a given search space.

In a common search space, Yₖ is set to 0 in relation to L=4 and L=8, that is, 2 aggregation levels. In a UE-specific search space having an aggregation level L, a parameter Yₖ is defined as in Equation 2 below.

Yₖ=(A·Yₖ₋₁)mod D <Equation 2>

In Equation, Y₋₁=n_{RNTI}≠0, A=39827, D=65537, and k=└nₛ/2┘. nₛ is a slot number within a radio frame.

When a wireless device monitors a PDCCH based on a C-RNTI, a DCI format and a search space to be monitored are determined depending on a transmission mode of a PDSCH. The following table shows an example in which a PDCCH in which a C-RNTI is set is monitored.

TABLE 2

| Transmission | | | Transmission mode of PDSCH |
|---|---|---|---|
| mode | DCI format | Search space | according to PDCCH |
| Mode 1 | DCI format 1A | common and | Single-antenna port, port 0 |
| | | UE-specific | |
| | DCI format 1 | UE-specific | Single-antenna port, port 0 |
| Mode 2 | DCI format 1A | common and | Transmit diversity |
| | | UE-specific | |
| | DCI format 1 | UE-specific | Transmit diversity |
| Mode 3 | DCI format 1A | common and | Transmit diversity |
| | | UE-specific | |
| | DCI format 2A | UE-specific | Cyclic Delay Diversity (CDD) or |
| | | | transmit diversity |
| Mode 4 | DCI format 1A | common and | Transmit diversity |
| | | UE-specific | |
| | DCI format 2 | UE-specific | Closed-loop spatial multiplexing |
| Mode 5 | DCI format 1A | common and | Transmit diversity |
| | | UE-specific | |
| | DCI format 1D | UE-specific | Multi-User Multiple Input Multiple |
| | | | Output (MU-MIMO) |
| Mode 6 | DCI format 1A | common and | Transmit diversity |
| | | UE-specific | |
| | DCI format 1B | UE-specific | Closed-loop spatial multiplexing |
| Mode 7 | DCI format 1A | common and | If the number of PBCH transmission ports |
| | | UE-specific | is 1, single antenna port, port 0, |
| | | | and if not, transmit diversity |
| | DCI format 1 | UE-specific | Single antenna port, port 5 |
| Mode 8 | DCI format 1A | common and | If the number of PBCH transmission ports |
| | | UE-specific | is 1, single antenna port, port 0, |
| | | | and if not, transmit diversity |
| | DCI format 2B | UE-specific | Dual layer transmission (port 7 or 8), |
| | | | or a single antenna port, port 7 or 8 |

The use of DCI formats is classified as in the following table.

TABLE 3

| DCI format | contents |
|---|---|
| DCI format 0 | Used for PUSCH scheduling |
| DCI format 1 | Used for the scheduling of one PDSCH codeword |
| DCI format 1A | Used for compact scheduling and a random access |
| | process of one PDSCH codeword |
| DCI format 1B | Used for the compact scheduling of one PDSCH |
| | codeword having precoding information |
| DCI format 1C | Used for the very compact scheduling of one PDSCH |
| | codeword |
| DCI format 1D | Used for the precoding and compact scheduling of |
| | one PDSCH codeword having power offset information |
| DCI format 2 | Used for the PDSCH scheduling of MSs set in |
| | closed-loop spatial multiplexing mode |
| DCI format 2A | Used for the PDSCH scheduling set in |
| | open-loop spatial multiplexing mode |
| DCI format 3 | Used to send a TPC command for a PUCCH |
| | and a PUSCH having 2-bit power adjustments |
| DCI format 3A | Used to send a TPC command for a PUCCH |
| | and a PUSCH having 1-bit power adjustment |

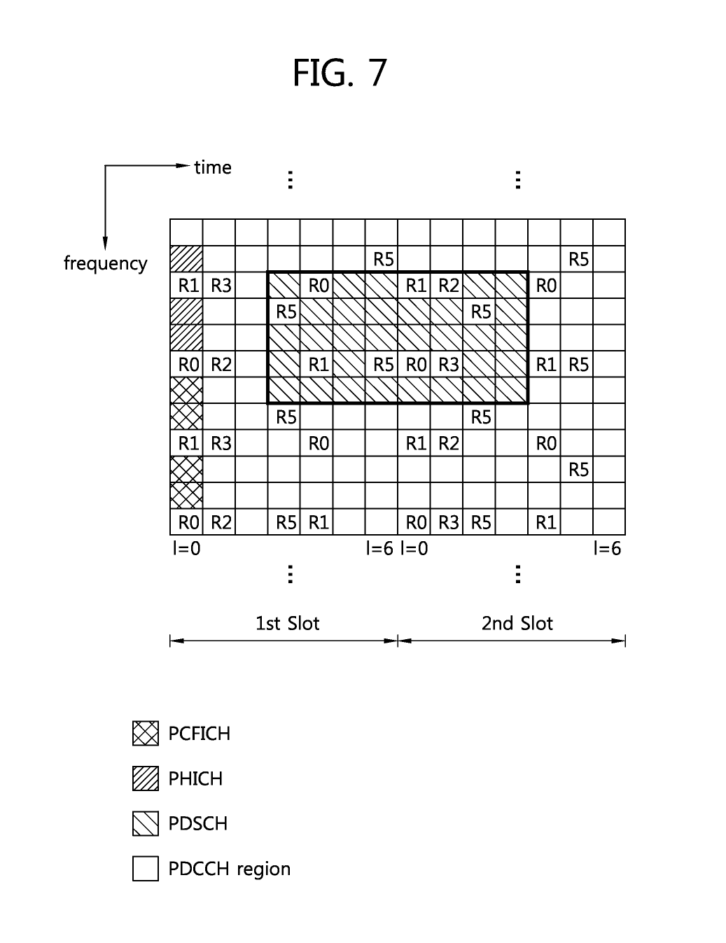

FIG. 7 shows an example in which reference signals and control channels are arranged in a downlink subframe of 3GPP LTE.

The downlink subframe can be divided into a control region and a data region. For example, in the downlink subframe, the control region (or PDCCH region) includes former 3 OFDM symbols, and the data region in which PDSCHs are transmitted includes the remaining OFDM symbols.

A physical control format indicator channel (PCFICH), a physical HARQ ACK/NACK indicator channel (PHICH) and/or a PDCCH are transmitted within the control region.

The PHICH can send hybrid automatic retransmission request (HARQ) information as a response to uplink transmission.

The PCFICH can send information about the number of OFDM symbols allocated to a PDCCH. For example, the Control Format Indicator (CFI) of the PCFICH can indicate 3 OFDM symbols. In the control region, regions other than resources in which the PCFICH and/or the PHICH are transmitted are PDCCH regions in which UE monitors a PDCCH.

Furthermore, various types of reference signals can be transmitted in the subframe.

A Cell-specific Reference Signal (CRS) is a reference signal that can be received by all MSs within a cell and can be transmitted in the entire DL frequency band. In FIG. 6, ‘R0’ is an RE in which a CRS for a first antenna port is transmitted, ‘R1’ is an RE in which a CRS for a second antenna port is transmitted, ‘R2’ is an RE in which a CRS for a third antenna port is transmitted, and ‘R3’ is an RE in which a CRS for a fourth antenna port is transmitted.

An RS sequence r_{l,n}_{ₛ} (m) for a CRS is defined as follows.

$${r}_{l , ns} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad 〈 Equation 3 〉$$

In Equation 3, m=0, 1, . . . , 2N_{RB}^{max,DL}−1, N_{RB}^{max,DL} is a maximum number of RBs, ns is a slot number within a radio frame, and 1 is an index of an OFDM symbol within a slot.

A pseudo-random sequence c(i) is defined by a Gold sequence having a length of 31 as follows.

c(n)=(x₁(n+Nc)+x₂(n+Nc))mod 2

x₁(n+31)=(x₁(n+3)+x₁(n))mod 2

x₂(n+31)=(x₂(n+3)+x₂(n+2)+x₂(n+1)+x₂(n))mod 2 <Equation 4>

In Equation 4, Nc=1600, and a first m-sequence is reset as follows: x1(0)=1, x1(n)=0, m=1, 2, . . . , 30. A second m-sequence is reset to cᵢₙᵢₜ=2¹⁰·(7·(nₛ+1)+l+1)·(2·N_{ID}^{cell}+1)+2·N_{ID}^{cell}+N_{CP} at the start of each OFDM symbol. N_{ID}^{cell} is a Physical Cell Identifier (PCI) of a cell. N_{CP}=1 in the case of a normal CP, and N_{CP}=0 in the case of an extended CP.

Furthermore, a UE-specific Reference Signal (URS) can be transmitted in the subframe. The CRS is transmitted in the entire region of the subframe, but the URS is transmitted within the data region of the subframe and is a reference signal used to demodulate a PDSCH. In FIG. 7, ‘R5’ indicates an RE in which a URS is transmitted. A DM-RS is used to demodulate EPDCCH data.

The URS can be transmitted in an RB to which corresponding PDSCH data is subject to resource mapping. FIG. 7 shows R5 in addition to regions in which PDSCH data is transmitted. R5 indicates the position of an RE to which the URS is mapped.

The URS can be a reference signal demodulated by only specific UE. An RS sequence r_{l,n}_{ₛ} (m) for the URS is the same as Equation 3. Here, m=0, 1, . . . , 12N_{RB}^{PDSCH}−1, and N_{RB}^{PDSCH} is the number of RBs used to send a corresponding PDSCH. If the URS is transmitted through a single antenna, a pseudo random sequence generator is reset to Cᵢₙᵢₜ=(└nₛ/2┘+1)·(2N_{ID}^{cell}+1)·2¹⁶+n_{RNTI} at the start of each subframe. n_{RNTI} is the identifier of a wireless device.

The above-described reset method corresponds to a case where a URS is transmitted through a single antenna. When a URS is transmitted through multiple antennas, a pseudo random sequence generator is reset to cᵢₙᵢₜ=(└nₛ/2┘+1)·(2n_{ID}⁽ⁿ^{_{SCID}}⁾+1)·2¹⁶+n_{SCID} at the start of each subframe. n_{SCID} is a parameter obtained from a DL grant (e.g., DCI format 2B or 2C) related to PDSCH transmission.

A URS supports Multiple Input Multiple Output (MIMO) transmission. An RS sequence for the URS can be spread into the following spreading sequence depending on an antenna port or a layer.

TABLE 4

| Layer | [w(0) w(1) w(2) w(3)] |
|---|---|
| 1 | [+1 +1 +1 +1] |
| 2 | [+1 −1 +1 −1] |
| 3 | [+1 +1 +1 +1] |
| 4 | [+1 −1 +1 −1] |
| 5 | [+1 +1 −1 −1] |
| 6 | [−1 −1 +1 +1] |
| 7 | [+1 −1 −1 +1] |
| 8 | [−1 +1 +1 −1] |

A layer can be defined as an information path to a precoder. A rank is the number of non-zero eigenvalues of an MIMIO channel matrix which is not 0 and is equal to the number of layers or the number of spatial streams. A layer can correspond to an antenna port for classifying URSs and/or a spread sequence applied to an URS.

Meanwhile, a PDCCH is monitored in a limited region called a control region within a subframe, and a CRS transmitted in all bands is used to demodulate the PDCCH. As the type of control information is diversified and the amount of control information is increased, the flexibility of scheduling using only an existing PDCCH is low. Furthermore, in order to reduce overhead due to CRS transmission, an enhanced physical downlink control channel (EPDCCH) is being introduced.

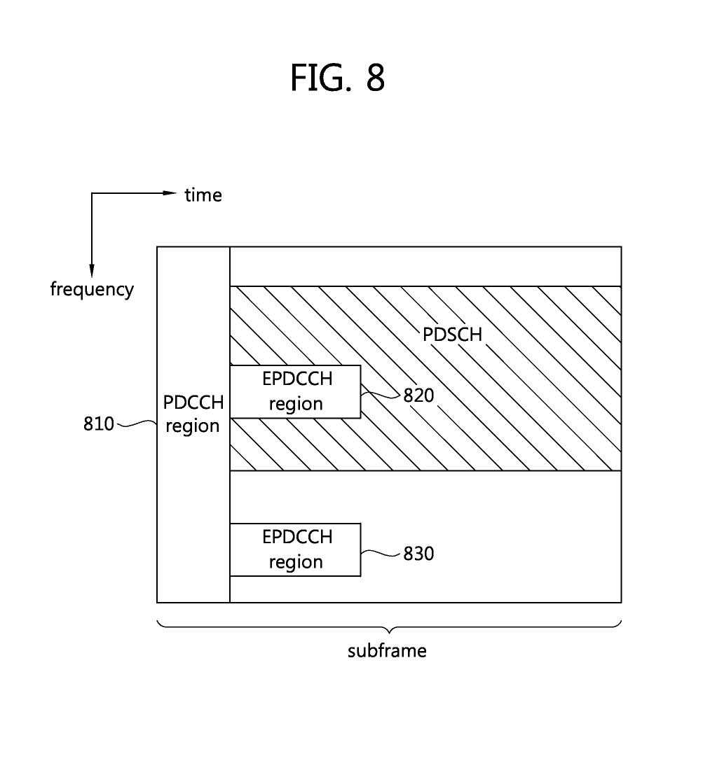

FIG. 8 shows an example of a subframe having EPDCCHs.

The subframe can include 0 or one PDCCH region 810 and 0 or more EPDCCH regions 820 and 830.

The EPDCCH regions 820 and 830 are regions in which UE monitors an EPDCCH. The PDCCH region 810 is located within former 3 OFDM symbols or a maximum of 4 OFDM symbols within a subframe, whereas the EPDCCH regions 820 and 830 can be flexibly scheduled in OFDM symbols posterior to the PDCCH region 810.

One or more EPDCCH regions 820 and 830 can be designated in UE, and the UE can monitor EPDCCH data in the designated EPDCCH regions 820 and 830.

A BS can inform UE of information about the number/location/size of the EPDCCH regions 820 and 830 and/or a subframe in which EPDCCH data will be monitored through a Radio Resource Control (RRC) message.

In the PDCCH region 810, PDCCH data can be demodulated based on a CRS. In the EPDCCH regions 820 and 830, a demodulation (DM) RS not a CRS can be defined in order to demodulate EPDCCH data. The DM RS can be transmitted in corresponding EPDCCH regions 820 and 830.

An RS sequence for the DM-RS is the same as Equation 3. Here, m=0, 1, . . . , 12N_{RB}^{max,DL}−1, and N_{RB}^{max,DL} is a maximum number of RBs. A pseudo random sequence generator can be reset to cᵢₙᵢₜ=(└nₛ/2┘+1)·(2n_{ID,i}^{EPDCCH}+1)·2¹⁶+n_{SCID}^{EPDCCH} at the start of each subframe. Ns is a slot number within a radio frame, n_{ID,i}^{EPDCCH} is a cell index related to a corresponding EPDCCH region, and n_{SCID}^{EPDCCH} is a parameter given from higher layer signaling.

The EPDCCH regions 820 and 830 can be used for scheduling for different cells. For example, an EPDCCH within the EPDCCH region 820 can carry scheduling information for a primary cell, and an EPDCCH within the EPDCCH region 830 can carry scheduling information for a secondary cell.

When EPDCCHs are transmitted through multiple antennas in the EPDCCH regions 820 and 830, the same precoding as that of the EPDCCH can be applied to DM RSs within the EPDCCH regions 820 and 830.

If a PDCCH uses a CCE as a transmission resource unit, a transmission resource unit for an EPDCCH is called an Enhanced Control Channel Element (ECCE). An aggregation level can be defined as a resource unit for monitoring an EPDCCH. For example, assuming that 1 ECCE is a minimum resource for an EPDCCH, an aggregation level L={1, 2, 4, 8, 16} can be defined. A search space can be defined even in the EPDCCH region. UE can monitor an EPDCCH candidate based on an aggregation level.

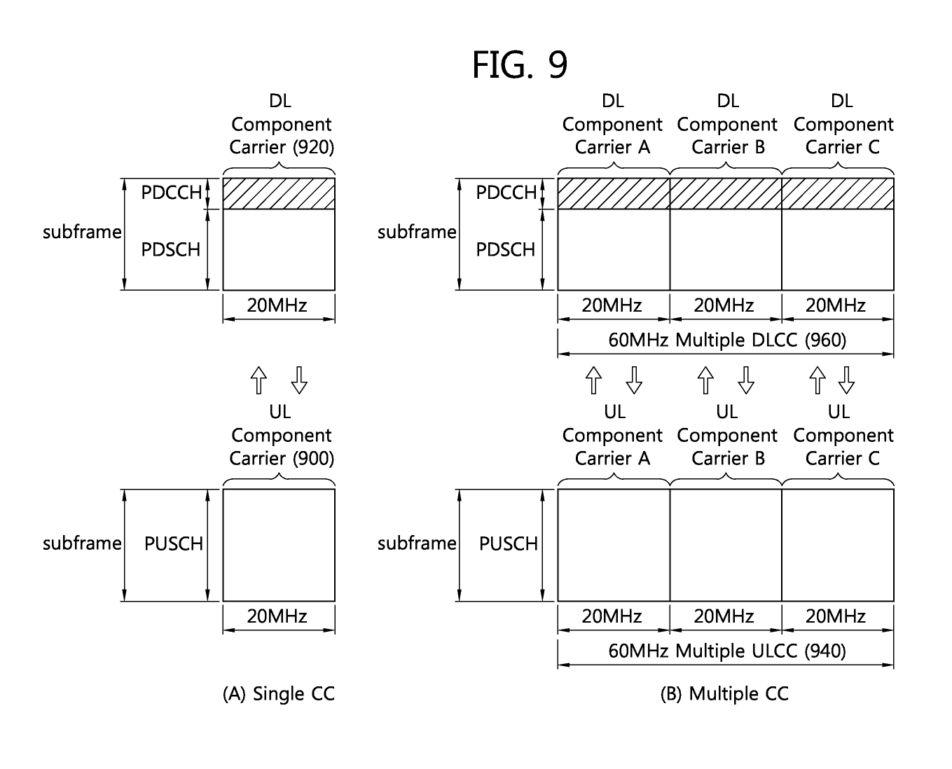

FIG. 9 is a conceptual diagram showing carrier aggregations.

FIG. 9(A) shows a single Component Carrier (CC). The single CC can be an UL frequency band 900 and a DL frequency band 920 of 20 MHz. FIG. 9(B) shows multiple CCs. The multiple CCs can be an UL frequency band 940 and a DL frequency band 960 of 60 MHz in which, for example, UL frequency bands and DL frequency bands of 20 MHz are aggregated.

A BS can send data to UE through a plurality of downlink CCs by performing a carrier aggregation. The BS can perform downlink transmission using N downlink CCs. Here, if UE can receive downlink data through only M (M is a natural number smaller than or equal to N) downlink CCs, the UE can receive only downlink data transmitted only the M downlink CCs from the BS.

In addition, a BS can set a frequency bandwidth, corresponding to L (L is a natural number smaller than or equal to M and N) downlink CCs, as a main CC and operate the frequency bandwidth. UE can preferentially monitor and receive data transmitted by a BS through a main CC. If a carrier aggregation is performed, a CC can be classified according to a cell.

If a carrier aggregation is performed using the CC of a Primary cell (PCell) and the CC of a Secondary cell (SCell), a carrier corresponding to the CC of a PCell, from among carriers used in downlink and uplink, is called a Primary cell Component Carrier (PCC) and a carrier corresponding to the CC of an SCell, from among the carriers used in downlink and uplink, is called a Secondary cell Component Carrier (SCC).

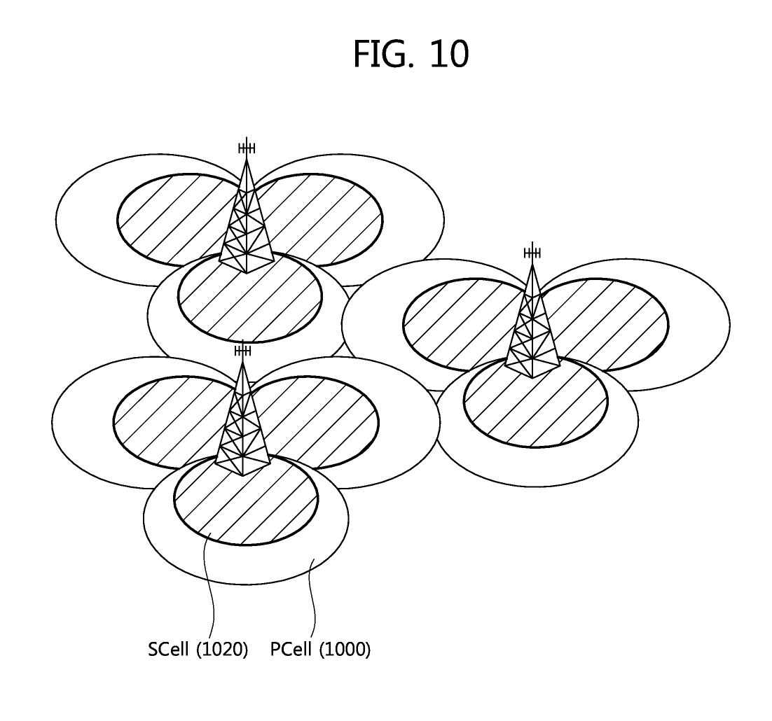

FIG. 10 is a conceptual diagram showing PCells and SCells.

Referring to FIG. 10, a BS can perform a carrier aggregation based on the PCC of a PCell 1000 and the SCCs of one or more SCells 1020. If 2 or more cells are present, the BS can determine one cell as the PCell 1000 and determine the remaining cells as the SCells 1020. The BS can aggregate the CCs of the determined PCell 1000 and SCells 1020 and send data to UE using an aggregated frequency bandwidth. The UE can send data to the BS using an aggregated frequency bandwidth. The PCell 1000 and the SCell 1020 disclosed in FIG. 10 correspond to one exemplary form of scenarios in which the PCell 1000 and the SCell 1020 are deployed and show a case where a data transmission range based on the PCC of the PCell 1000 is greater than a data transmission range based on the SCC of the SCell 1020.

UE can perform Radio Resource Control (RRC) connection through the PCC of the PCell 1000. Furthermore, the UE can attempt random access to a BS through a physical random access channel (PRACH) based on a signal signaled through the PCC. That is, the UE can perform an initial connection establishment process or a connection re-establishment process on the BS through the PCC in a carrier aggregation environment.

The SCC of the SCell 1020 can be used to provide additional radio resources. In order to perform a carrier aggregation for adding the SCC to the PCC, the UE needs to perform neighbor cell measurement for obtaining information about neighbor cells. The BS can determine whether or not to aggregate the SCC into the PCC based on the neighbor cell measurement performed by the UE. For example, a legacy subframe can be transmitted through the PCC in the PCell, and an NCT subframe to be described later can be transmitted through the SCC in the SCell. The legacy subframe is a subframe different from the subframe formats defined prior to the 3GPP LTE-A release 11 or the NCT subframe newly defined in the 3GPP LTE-A release 12.

The BS can send PDCCH data to the UE through the PCC. The PDCCH data can include allocation information about PDSCH data transmitted through a downlink PCC band and SCC band and information that approves data transmission through uplink.

The PCell 1000 and the SCell 1020 can perform a carrier aggregation through a configuration and an activation operation and transmit and receive data through an aggregated frequency band.

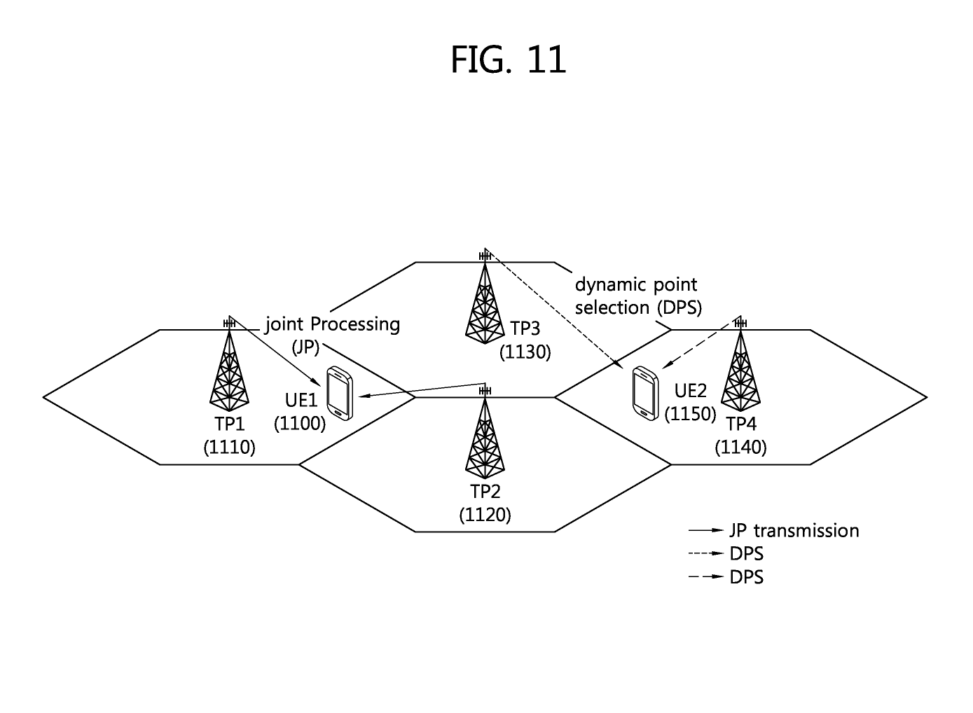

FIG. 11 is a conceptual diagram showing a method of transmitting data to UE based on a Coordinated Multi-Point (CoMP) in plurality of TPs.

Referring to FIG. 11, traffic data and control data can be transmitted to the UE based on a CoMP at a plurality of Transmission Points (TPs). The plurality of TPs can generate data transmitted to the UE within a cell based on the same cell ID or different cell IDs. The plurality of TPs may be called a plurality of serving cells or cells as another term, and the CoMP may transmit and receive data based on different serving cells.

A TP 1 1110 and a TP 2 1120 send data to UE 1 1100 using a Joint Transmission (JT) method of a CoMP. If the plurality of TP 1 1110 and TP 2 1120 sends data to the UE 1 1100 using a JT method, the TPs 1 and 2 1110 and 1120 can send the same data to the UE 1100 at the same time. The UE 1 1100 can receive the same data from the TP 1 1110 and the TP 2 1120 and demodulate the received data.

A TP 3 1130 and a TP 4 1140 can send data to UE 2 1150 using a Dynamic Point Selection (DPS) method of a CoMP.

In the DPS method, the UE 2 1150 can dynamically select a TP having a better channel from the different TPs 3 and 4 1130 and 1140, and receive data from the selected TP. For example, if the TP 3 1130 sends EPDCCH data to the UE 2 1150 at a first time, the TP 4 1140 can send EPDCCH data to the UE 2 1150 at a second time.

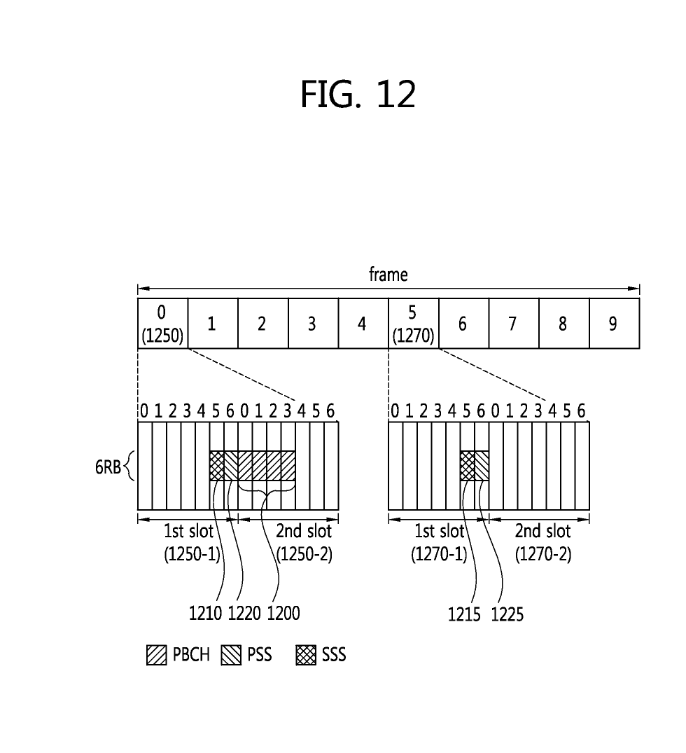

FIG. 12 shows the transmission of a synchronization signal and PBCH data in a legacy subframe when Frequency Division Duplexing (FDD) is used in according to a duplexing method.

A physical broadcast channel (PBCH) 1200 is transmitted in former 4 OFDM symbols of a second slot 1250-2 in the first subframe (i.e., subframe 1250 having an index 0) of a radio frame. The PBCH 1200 carries system information essential for a wireless device to communicate with a BS, and system information transmitted through the PBCH 1200 is called a Master Information Block (MIB). In contrast, system information transmitted on a PDSCH that is indicated by a PDCCH is called a System Information Block (SIB).

Seventh OFDM symbols (i.e., OFDM symbol having an index 6), from among OFDM symbols allocated to the first slots 1250-1 and 1270-1 of the first subframe (i.e., subframe 1250 having an index 0) and a sixth subframe (i.e., subframe 1270 having an index 5), can include respective Primary Synchronization Signals (PSSs) 1220 and 1225. The PSSs 1220 and 1225 can be used to obtain OFDM symbol synchronization or slot synchronization. Furthermore, information about a physical cell ID can be obtained through the PSSs 1220 and 1225. A Primary Synchronization Code (PSC) is a sequence used to generate the PSSs 1220 and 1225. In 3GPP LTE, a PSS can be generated by defining a plurality of PSCs. A BS generates the PSSs 1220 and 1225 using one of 3 PSCs based on a cell ID. UE can receive the PSSs 1220 and 1225 and obtain information about a cell ID based on a PSC.

Sixth OFDM symbols (i.e., OFDM symbol having an index 5), from among the OFDM symbols allocated to the first slots 1250-1 and 1270-1 of the first subframe (i.e., subframe 1250 having an index 0) and the sixth subframe (i.e., subframe 1270 having an index 5), can include respective Secondary Synchronization Signals (SSSs) 1210 and 1215.

The first SSS 1210 can be transmitted through the sixth OFDM symbol of the first slot 1250-1 of the first subframe 1250, and the second SSS 1215 can be transmitted through the sixth OFDM symbol of the first slot 1270-1 of the sixth subframe 1270. The SSSs 1210 and 1215 can be used to obtain frame synchronization. The SSSs 1210 and 1215, together with the PSSs 1220 and 1225, are used to obtain information about a cell ID.

The first SSS 1210 and the second SSS 1215 can be generated using different Secondary Synchronization Codes (SSCs). Assuming that each of the first SSS 1210 and the second SSS 1215 includes 31 subcarriers, 2 SSC sequences having a length of 31 are used in the first SSS 1210 and the second SSS 1215, respectively.

From a viewpoint of a frequency domain, PBCHs 1200, the PSS 1220, 1225, and the SSS 1210, 1215 are transmitted within a frequency bandwidth corresponding to 6 RBs on the basis of the center frequency of the subframe.

In a new LTE-A release, a subframe having a new format can be defined and used. The newly defined subframe can be defined as a term called a New Carrier Type (NCT) subframe (or new carrier subframe). The NCT subframe can be defined and used in detail.

In the existing LTE release 8/9/10 systems, a control channel, a reference signal, and a synchronization signal, such as a CRS, a PSS/SSS, a PDCCH, and PBCHs, can be transmitted through a downlink carrier. A subframe in which the control channel, the reference signal, and the synchronization signal are defined can be called a legacy subframe. In systems posterior to the LTE release 8/9/10 systems, some of channels or signals transmitted in an existing legacy subframe may not be transmitted in order to improve an interference problem between a plurality of cells and improve carrier extensibility. This subframe can be defined as a term called an extension carrier subframe or an NCT subframe. For example, the NCT subframe may not include PDCCH data, a control channel, such as a CRS, and/or information about a reference signal. For example, if a PDCCH is not present in the NCT subframe, control information can be transmitted through an EPDCCH. The PDSCH of the NCT subframe can be allocated based on the EPDCCH included in the NCT subframe.

It may be assumed that both a legacy subframe and an NCT subframe are transmitted by a plurality of TPs based on a CoMP. In this case, a PDCCH included in the legacy subframe can include information about the allocation of a PDSCH transmitted through the NCT subframe. Downlink control information, such as DCI, can be transmitted in the NCT subframe through an EPDDCH. Since a CRS is not transmitted in the NCT subframe, the DCI can be demodulated based on a reference signal, such as a DM-RS. The NCT subframe can be called an NCT subframe even when the NCT subframe and a legacy subframe have been configured in one subframe in accordance with a Time Division Multiplexing (TDM) method. For example, even when one slot is generated by configuring the channel and signal of an NCT subframe and the other slot is generated by configuring the channel and signal of a legacy subframe, the corresponding subframe can be called an NCT subframe. Furthermore, the NCT subframe and the legacy subframe can be split based on the time within one frame in accordance with a TDM method and then transmitted. For example, a frame transmitted in one cell can include both an NCT subframe and a legacy subframe, and this frame may also be called an NCT frame.

Assuming a PCell that sends data based on a legacy subframe and an SCell that sends data using an NCT subframe, data can be transmitted to UE based on the PCell and the SCell. That is, the NCT subframe can be a subframe that is transmitted in an SCC, that is, a frequency band allocated to the SCell. When sending data to the UE based on the PCell and the SCell, a BS can inform the SCell of the position of an OFDM symbol at which a PDSCH is started in the legacy subframe through higher layer signaling. A parameter informing the position of the OFDM symbol at which the PDSCH is started in the legacy subframe is an ldatastart parameter. The ldatastart parameter can have a value of 1 to 4.

An NCT frame including the NCT subframe can include 10 NCT subframes. The NCT frame can send a reference signal that perform time/frequency tracking only in specific subframes not all the NCT subframes included in the NCT frame. The reference signal, included and transmitted in the NCT subframe and performing time/frequency tracking, can be called a Tracking Reference Signal (TRS). Instead of the term ‘TRS’, the reference signal, included and transmitted in the NCT subframe and performing time/frequency tracking, can be represented by a term ‘enhanced Synchronization Signal (eSS)’ or ‘reduced CRS’. The TRS can be transmitted in specific subframes (e.g., a subframe 0 a subframe 5) of one NCT frame. The TRS can be a reference signal defined in such a way as to be transmitted in an RE specified in a specific RB of the NCT subframe.

In the NCT subframe, PDSCH data may not be mapped to an RE in which the TRS has been configured. That is, in the NCT subframe, data rate matching can be performed on PDSCH data by taking an RE in which a TRS has been configured into consideration. Another NCT subframe can be a subframe obtained by puncturing an RE in which a TRS has been configured.

An antenna port for sending a TRS can be defined as an antenna port x. When a BS sends a TRS to UE based on the antenna port x, the BS may not map the data of a PDSCH or EPDCCH in an RE corresponding to the antenna port x through which the TRS is transmitted.

An initial value of a pseudo random sequence used to generate a TRS can be determined based on cᵢₙᵢₜ=2¹⁰·(7·(nₛ+1)+l+1)·(2·N_{ID}^{cell}+1)+2·N_{ID}^{cell}+N_{CP}. Here, nₛ can be a slot number, l can be an OFDM symbol number, N_{ID}^{cell} can be a cell identifier, and N_{CP} can be the length of a CP. N_{CP} can have a different value depending on the type of CP.

A v-shift can be used as a parameter for reducing the influence of inter-cell interference. The v-shift can be used as a parameter for coordinating the position of an RE to which a TRS is mapped. For example, the v-shift can be determined based on v_{shift}=N_{ID}^{cell} mod 6. The v-shift can be a fixed value, such as 0.

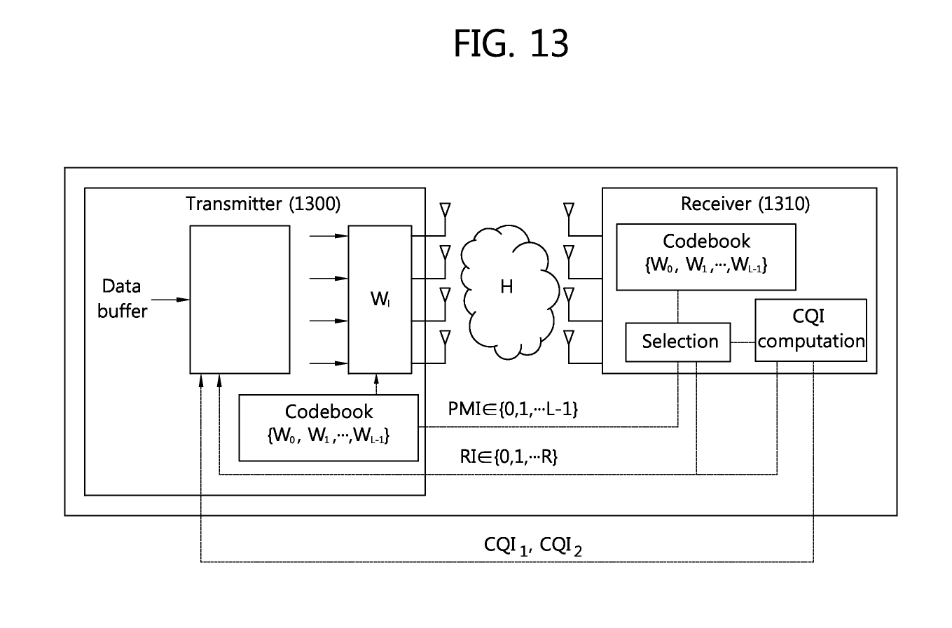

FIG. 13 is a conceptual diagram showing the transmission of a CSI-RS and the feedback of CSI measured by UE.

Referring to FIG. 13, UE 1310 can feed channel information, calculated based on a CSI-RS transmitted by a BS 1300, back to the BS 1300 using parameters, such as a Rank Index (RI), a Precoding Matrix Index (PMI), and a Channel Quality Indicator (CQI). The parameters indicative of channel information, such as an RI, a PMI, and a CQI, can be called Channel State Information (CSI) feedback information. The pieces of CSI feedback information can perform the following functions.

(1) The Rank Index (RI) can include information about a transmission rank. That is, information about the number of layers used in downlink transmission can be provided to a BS based on the RI.

(2) The Precoding Matrix Index (PMI) can include information about a precoding matrix used in downlink transmission.

(3) The Channel Quality Indicator (CQI) can include information about a Modulation and Coding Scheme (MCS).

The UE 1310 can report information about a downlink channel state by sending an RI, a PMI, and a CQI, that is, pieces of information indicative of the channel state, as feedback information in response to a CSI-RS received from the BS 1300.

The CRS is also a reference signal that can be used by UE in order to obtain downlink CSI. Accordingly, the role of the CRS may overlap with the role of the CSI-RS. The CSI-RS can be used to supplement the CRS, that is, an already present reference signal. As the number of transmission antennas increases, the CSI-RS can be used to better determine CSI than the CRS, that is, an existing reference signal. Furthermore, the density of the existing CRS is high because the CRS is configured to perform channel measurement in a channel situation that is changed very fast. Accordingly, the CRS functions as high overhead. In contrast, the CSI-RS has a low time-frequency density because it is a reference signal for obtaining only CSI. Accordingly, the CSI-RS has relatively lower overhead than the CRS. As a result, the CSI-RS having a low time-frequency density and low overhead can be defined as a new type of a reference signal rather than extending the CRS, that is, an existing reference signal.

One cell or BS can include 1, 2, 4, or 8 CSI-RSs for each RB pair and send them to UE. A CSI-RS configuration showing a structure in which CSI-RSs are arranged on a resource grid can have a different CSI-RS configuration depending on the number of CSI-RSs used in one cell. A CRS configuration and a CSI-RS configuration can be configuration information about CRS and CSI-RS transmitted by the higher layer. For example, the CRS configuration and the CSI-RS configuration can include the number of the antenna ports transmitting the CRS and the CSI-RS as a information element.

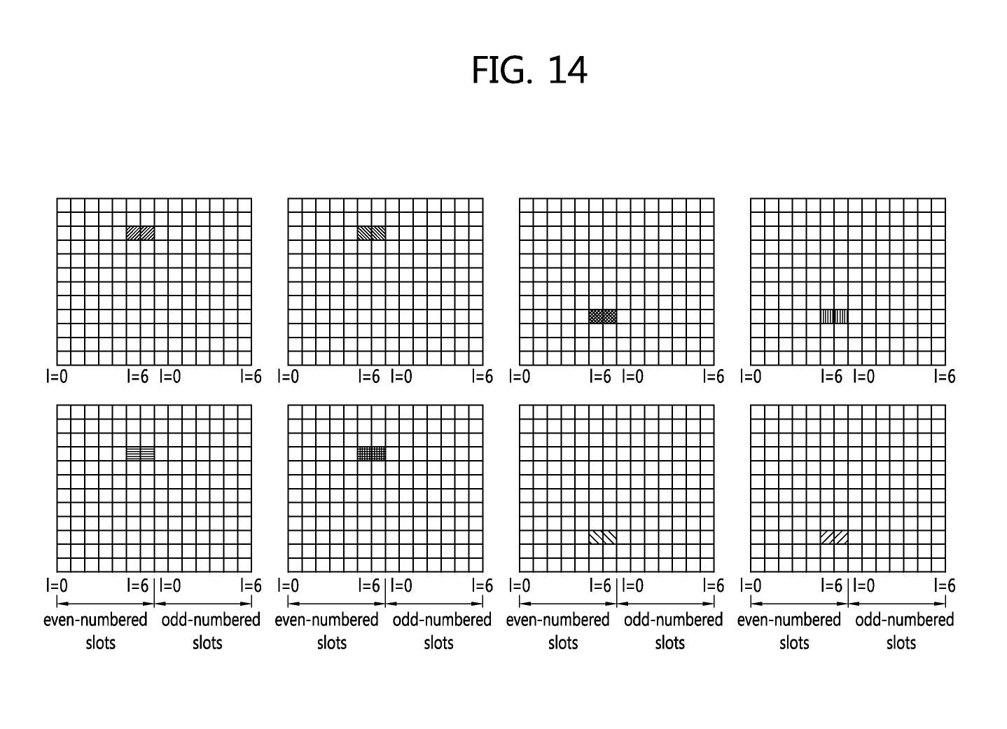

FIG. 14 is a conceptual diagram showing the configuration of CSI-RSs in an RB pair depending on the number of CSI-RSs in accordance with an embodiment of the present invention.

In FIG. 14, an RB pair shows a case where a CSI-RS has been allocated to two REs. A part indicated by a shadow indicates a part where a CSI-RS can be placed in the RB pair. Furthermore, 1, 4, or 8 CSI-RSs may be allocated to one RB pair.

For example, two CSI-RSs can be placed in two consecutive REs on a time axis in one RB. The two CSI-RSs can avoid mutual interference using respective Orthogonal Cover Codes (OCCs).

From a viewpoint of a time domain, an interval during which a CSI-RS is transmitted can be various from 5 ms (every fifth subframe) to 80 ms (every eighth frame). If one CSI-RS is transmitted every 5 ms, overhead occurring because the CSI-RS is used can be 0.12%. In order to avoid interference with neighbor cells, a subframe in which the CSI-RS is transmitted can have a different value from those of neighbor cells on a time domain.

FIG. 14 illustrates that a CSI-RS is transmitted in one RB, but the CSI-RS can be transmitted through the entire system bandwidth.

Referring back to FIG. 14, a CSI-RS may be transmitted in other places not the position disclosed in FIG. 14, depending on a CSI-RS configuration. That is, the CSI-RS can be transmitted in the position of another RE other than the current position of the CSI-RS. An RE not used in the CSI-RS, from among REs corresponding to the potential position of the CSI-RS, can be used for the transmission of PDSCH data. An RE corresponding to the potential position of the CSI-RS may also be used as a muted CSI-RS (or zero-power CSI-RS) in another way. The muted CSI-RS is the same as a common CSI-RS configuration, but anything may not be transmitted in the position of a corresponding RE.

If a CSI-RS is transmitted by other neighbor cells, the muted CSI-RS of a current cell can become a “transmission hole”. The “transmission hole” can be used to receive the CSI-RSs of neighbor cells with no influence on transmission in its own cell. For example, channel information about neighbor cells can be obtained by receiving the CSI-RSs or data transmitted via a data channel of the neighbor cells. The channel information based on the CSI-RSs of the neighbor cells can be used in multi-cell transmission technology, such as Cooperative Multi-Point (CoMP).

A CSI-RS configuration can be different within an RB pair depending on the number of antenna ports, and CSI-RS configurations can be configured to be different to the highest degree between neighbor cells.

Furthermore, a CSI-RS configuration within an RB pair can be classified depending on the type of Cyclic Prefix (CP). Furthermore, a CSI-RS configuration can be divided into a case applied to both a frame structure 1 and a frame structure 2 and a case applied to only the frame structure 2. Here, the frame structure 1 and the frame structure 2 can be classified depending on whether a transmission method is Time Division Duplexing (TDD) or Frequency Division Duplexing (FDD).

Furthermore, a CSI-RS, unlike a CRS, supports a maximum of 8 ports p=15, p=15,16, p=15, . . . , 18, and p=15, . . . , 22, and the CSI-RS can be defined for Δf=15 kHz.

An RS sequence for a CSI-RS can be calculated according to the following method.

The RS sequence r_{l,n}_{ₛ}(m) for a CSI-RS is generated as in the following equation.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1 where , \\ {c}_{init} = {2}^{10} \cdot ( 7 \cdot ( {n}_{s} + 1 ) + l + 1 ) \cdot ( 2 \cdot {N}_{ID}^{cell} + 1 ) + 2 \cdot {N}_{ID}^{cell} + {N}_{CP} \\ {N}_{CP} = \{ \begin{matrix}1 & for normal CP \\ 0 & for extended CP\end{matrix} \qquad 〈 Equation 5 〉$$

In Equation 5, nₛ is a slot number (or index) within one radio frame, and l is an OFDM symbol number within the slot. c(i) is a pseudo random sequence, cᵢₙᵢₜ, and started at each OFDM symbol. N_{ID}^{cell} is a physical layer cell ID.

An initial value of a pseudo random sequence can be calculated using cᵢₙᵢₜ=2¹⁰·(7·(nₛ+1)+l+1)·(2·N_{ID}^{CSI}+1)+2·N_{ID}^{CSI}+N_{CP}. Here, N_{CP} can have a different value (1 in the case of a normal CP and 0 in the case of an extended CP) depending on the type of CP. N_{ID}^{CSI} can have a value corresponding to N_{ID}^{cell} unless it is set in a higher layer.

r_{l,n}_{ₛ}(m) can be subject to resource mapping to a complex-valued modulation symbol a_{k,l}^{(p)}. Equation 6 below is an equation in which the reference signal the sequence r_{l,n}_{ₛ}(m) is mapped to the complex modulation symbol a_{k,l}^{(p)} used as a reference symbol for an antenna port p in subframes configured to send a CSI-RS.

$${a}_{k , l}^{( p )} = {w}_{{i}^{″}} \cdot {r}_{l , {n}_{s}} ( {m}^{′} ) \\ where \\ k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & \begin{matrix}CSI reference signal configurations 0 \text{-} 19 , \\ normal cyclic prefix\end{matrix} \\ 2 {l}^{″} & \begin{matrix}CSI reference signal configurations 20 \text{-} 31 , \\ normal cyclic prefix\end{matrix} \\ {l}^{″} & \begin{matrix}CSI reference signal configurations 0 \text{-} 27 , \\ normal cyclic prefix\end{matrix}\end{matrix} \\ {w}_{{l}^{″}} = \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0.1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋ \qquad 〈 Equation 6 〉$$

In Equation 2, (k′,l′) and nₛ are given in Table 1 and Table 2 below. A CSI-RS can be transmitted in a downlink slot in which (ns mod 2) satisfies the conditions of Table 1 and Table 2.

Table 1 below shows CSI-RS configurations for a normal CP.

TABLE 5

| | CSI reference | Number of CSI reference signals configured | | | | | |
|---|---|---|---|---|---|---|---|
| | signal | 1 or 2 | | 4 | | 8 | |
| | configuration | (k′, l′) | nₛ mod 2 | (k′, l′) | nₛ mod 2 | (k′, l′) | nₛ mod 2 |
| Frame structure | 0 | (9, 5) | 0 | (9, 5) | 0 | (9, 5) | 0 |
| type 1 and 2 | 1 | (11, 2) | 1 | (11, 2) | 1 | (11, 2) | 1 |
| | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame structure | 20 | (11, 1) | 1 | (11, 1) | 1 | (11, 1) | 1 |
| type 2 only | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

Table 6 below shows CSI-RS configurations for an extended CP.

TABLE 6

| | CSI reference | Number of CSI reference signals configured | | | | | |
|---|---|---|---|---|---|---|---|
| | signal | 1 or 2 | | 4 | | 8 | |
| | configuration | (k′, l′) | nₛ mod 2 | (k′, l′) | nₛ mod 2 | (k′, l′) | nₛ mod 2 |
| Frame structure | 0 | (11, 4) | 0 | (11, 4) | 0 | (11, 4) | 0 |
| type 1 and 2 | 1 | (9, 4) | 0 | (9, 4) | 0 | (9, 4) | 0 |
| | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| Frame structure | 16 | (11, 1) | 1 | (11, 1) | 1 | (11, 1) | 1 |
| type 2 only | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

Several CSI-RS configurations can be used in one cell. For example, a non-zero-power CSI-RS can use a 0 or 1 configuration, and a zero-power CSI-RS can use 0 or several configurations. That is, in relation to a non-zero-power CSI-RS and a zero-power CSI-RS, a BS can send a non-zero-power CSI-RS and/or a zero-power CSI-RS through a downlink channel based on various types of configurations. Configuration information about the non-zero-power CSI-RS and/or the zero-power CSI-RS can be transmitted by a higher layer.

A subframe configuration for a CSI-RS I_{CSI-RS} is indicated by a higher layer, and the subframe configuration for a CSI-RS I_{CSI-RS} informs a subframe configuration value and subframe offset value of the CSI-RS as in Table 3.

TABLE 3

| CSI-RS- | CSI-RS periodicity | CSI-RS subframe offset |
|---|---|---|
| SubframeConfig I_{CSI-RS} | T_{CSI-RS} (subframes) | Δ_{CSI-RS} (subframes) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |

Hereinafter, in an embodiment of the present invention, a method by which a plurality of TPs performs CSI feedback based on reference signals transmitted through a downlink channel is described. A plurality of TPs used herein may mean a plurality of cells.

In performing CSI feedback to a BS, UE can determine whether or not to feed a Precoding Matrix Index (PMI) and a Rank Index (RI) back based on the configuration of a higher layer. A BS can use the PMI and RI in order to determine a precoding matrix used to perform downlink transmission. That is, the UE can determine whether or not to include the PMI/RI in CSI feedback information, transmitted to the BS, depending on the setting of the parameters of a higher layer. For example, a parameter used to determine whether or not to feed the PMI/RI, transmitted from a higher layer to the UE, back to the BS can be a pmi-RI-report parameter.

For example, if a TDD method is used as a duplexing method, UE may not include a PMI/RI in CSI feedback information and send the CSI feedback information to a BS. If a TDD method is used as a duplexing method, a carrier frequency of a downlink channel is the same as a carrier frequency of an uplink channel. Accordingly, CSI about the downlink channel can be predicted based on CSI about the uplink channel on the basis of channel reciprocity. BS can receive an SRS, that is, a reference signal transmitted through an uplink channel, from UE and predict the state of a downlink channel based on the SRS. Furthermore, the BS can use CSI feedback information, not including a PMI/RI transmitted by the UE, in order to correct a value obtained by predicting the state of the downlink channel based on the SRS.

Hereinafter, in an embodiment of the present invention, a parameter, such as a pmi-RI-report parameter used to determine information fed back when UE performs CSI feedback, is defined as a feedback information parameter. In an embodiment of the present invention, the assumption and/or determination of UE for calculating CSI feedback information (e.g., a CQI index) based on a CSI reference resource are disclosed.

The CSI reference resource can indicate resources that are used by UE in order to obtain information (e.g., CSI feedback (or CQI index)) related to a downlink channel state. UE can determine a transmission mode of a BS and/or a channel and signal that are included in a subframe transmitted by the BS and can obtain CSI feedback based on the determination. For example, UE may not take a PDCCH and/or a CRS into consideration in order to calculate a CQI index in a subframe, such as an NCT subframe through which a control channel and/or a reference signal, such as a PDCCH and/or a CRS, are not transmitted. In contrast, in relation to a legacy subframe through which a PDCCH and a CRS are transmitted, UE may take resources, allocated to the PDCCH and the CRS, as resources for calculating a CQI index. Furthermore, UE can calculate a CQI index by performing a limit to the number of antenna ports, configured for a CSI-RS transmitted to the UE, based on a feedback information parameter. That is, UE can calculate a CQI index and/or a PMI and an RI as CSI feedback information by taking information about a channel and signal allocated to a subframe and/or information about a parameter set by a higher layer.

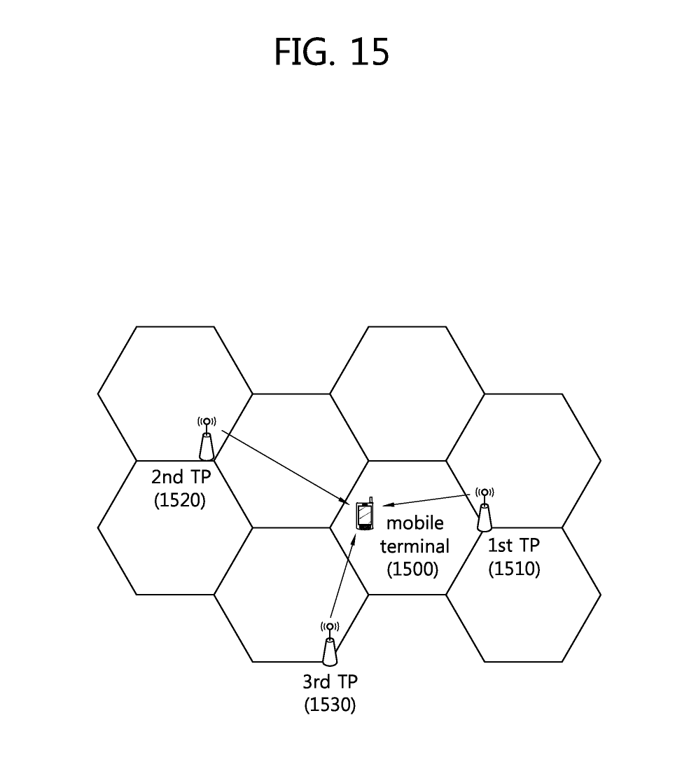

FIG. 15 is a conceptual diagram showing a method of performing CSI feedback based on signals transmitted by a plurality of TPs in accordance with an embodiment of the present invention.

FIG. 15 discloses a method of sending CSI feedback information between a plurality of TPs 1510, 1520, and 1530. It is assumed that the three TPs 1510, 1520, and 1530 send data to UE 1500 through downlink channels and the UE 1500 sends CSI feedback, not including a PMI/RI, to the plurality of TPs 1510, 1520, and 1530 based on the received data.

The three TPs 1510, 1520, and 1530 can predict downlink CSI based on channel reciprocity on the basis of an SRS transmitted by the UE 1500. However, since downlink transmission conditions are different from uplink transmission conditions, a TP performing a downlink CoMP can be different from a TP performing an uplink CoMP. In this case, the TP performing a downlink CoMP may not receive the SRS from the UE 1500 and cannot predict downlink channel information. Hereinafter, in an embodiment of the present invention, a TP performing a downlink CoMP is defined as a downlink TP, and a TP performing an uplink CoMP is defined as an uplink TP.

The downlink CoMP indicates that a plurality of TPs sends data to the UE 1500 based on a CoMP. The uplink CoMP indicates that a piece of UE 1500 sends data to a plurality of TPs. That is, the meaning that a downlink TP differs from an uplink TP may mean that a TP sending data to the UE 1500 is different from a TP sending data to the UE 1500. If a downlink TP is different from an uplink TP, a specific downlink TP may not receive CSI feedback and an SRS from the UE 1500. In order to solve this problem, a downlink TP and an uplink TP can be configured to be the same or an uplink TP can be configured to include a downlink TP. In this manner, the UE 1500 can send CSI feedback and an SRS through a downlink TP. For example, if downlink TPs are a first TP, a second TP, and a third TP, all the first TP, the second TP, and the third TP can be configured to be uplink TPs.

As another method, a downlink TP can be configured to receive an SRS and/or CSI feedback information transmitted by the UE 1500. That is, although a downlink TP is not an uplink TP, the downlink TP can receive an SRS and/or CSI feedback information transmitted by the UE 1500 and estimate a downlink channel based on the received SRS and/or CSI feedback information.

UE can perform hopping on an SRS, PUSCH data, and PUCCH data, transmitted through an uplink channel transmitted to a downlink TP, in accordance with a group hopping or sequence hopping method. An initial value of a pseudo random sequence used to perform group hopping or sequence hopping can be determined based on a different equation depending on a hopping method and target hopping data.

Equations 7 and 8 below are used to determine an initial value of a pseudo random sequence for performing group hopping and sequence hopping on an SRS and PUSCH data.

$${c}_{init} = ⌊ \frac{{VC}_{ID}}{30} ⌋ \qquad 〈 Equation 7 〉$$

Equation 7 is used to determine an initial value of a pseudo random sequence for determining a hopping pattern of an SRS when the SRS performs group hopping. In Equation 7, VCID is information about a cell ID.

$${c}_{init} = ⌊ \frac{{VC}_{ID}}{30} ⌋ \cdot {2}^{5} + {f}_{ss}^{PUSCH} \qquad 〈 Equation 8 〉$$

In Equation 8, fₛₛ^{PUSCH}=(fₛₛ^{PUCCH}+Δₛₛ)mod 30, Δₛₛε{0, 1, . . . , 29}, and fₛₛ^{PUCCH}=VC_{ID} mod 30.

Equation 8 is used to determine an initial value of a pseudo random sequence in order to determine a base sequence number when PUCCH data performs sequence hopping. In Equation 8, VCID is information about a cell ID, and fₛₛ^{PUCCH} can be a value calculated based on the VCID.

In Equations 7 and 8, VCID can be information set per UE. Furthermore, VCID can be information shared by downlink TPs. A downlink CSI estimated by a BS based on an SRS transmitted through an uplink channel can be shared by downlink TPs. For example, a downlink TP can send CSI feedback information, received from UE, to another downlink TP through an information transmission interface between TPs, such as an X2 interface. Pieces of information can be exchanged between TPs through a backhaul link if the backhaul link is ideal, but can be exchanged between TPs based on an X2 interface if the backhaul link is not ideal.

For example, it can be assumed that one TP is configured as a PCell, the other TP is configured as an SCell, and the PCell performs scheduling on traffic data transmitted by the SCell based on transmitted control data. In this case, the PCell can perform scheduling on traffic data, transmitted from the SCell to UE, based on CSI received from the SCell. In this case, a TP corresponding to the SCell can send downlink information, predicted based on CSI feedback information and an SRS, to a TP corresponding to the PCell. The PCell can determine pieces of information varying depending on a channel state, such as an MCS, a precoding matrix, and a CQI applied to the traffic data transmitted by the SCell, based on channel information between the SCell and the UE. Furthermore, the PCell can perform scheduling on the traffic data transmitted from the SCell to the UE. If the distance between a plurality of TPs and UE is far, information for synchronizing the transmission timing and the reception timing of data between the plurality of TPs and the UE can be transmitted based on an X2 interface.

The UE can determine a Channel Quality Indicator (CQI) based on a CRS or CSI-RS, that is, a reference signal transmitted by each TP.

The CSI determined by the UE can be transmitted through a PUCCH or PUSCH transmitted through an uplink channel. Like in the case where an uplink SRS is received by a downlink TP, the CQI determined by the UE can be received by a downlink TP through a PUCCH or PUSCH. For example, it can be assumed that a CQI is transmitted through a PUCCH. Group hopping and sequence hopping can be performed on data transmitted through a PUCCH, as described above.

An initial value of a pseudo random sequence used to perform group hopping and sequence hopping on the PUCCH data can be determined in accordance with Equations 7 and 8. VCID can be information about a cell ID or can be information transmitted from a higher layer to UE.

An initial value of a pseudo random sequence used to perform group hopping and sequence hopping on PUSCH data can be determined based on Equation 9.

cᵢₙᵢₜ=n_{RNTI}·2¹⁴+q·2¹³+└nₛ/2┘·2⁹+VC_{ID} <Equation 9>

In Equation 9, nRNTI is a UE ID, q is a codeword index, and ns is a slot index.

In accordance with another embodiment of the present invention, a CQI transmitted by UE can be configured in such a way as to be received only by a downlink TP. In order to configure a CQI transmitted by UE so that the CQI is heard by only a downlink CoMP TP, a pseudo random sequence can be reset using the cell ID of a TP performing a downlink CoMP instead of VCID, that is, a parameter used in Equations 7 to 9.

A specific transmission mode of a BS can support a CoMP, and UE can configure one or more CSI processes in each TP through a higher layer in a specific transmission mode (e.g., Transmission Mode (TM)) 10. One or more CSI processes configured in each TP can be associated with a CSI-RS resource and a CSI-Interference Measurement (IM) resource. Information for configuring the CSI-RS and the CSI-IM can be transmitted by a higher layer. The CSI-RS resource can be resources to which a zero-power CSI-RS is mapped. The CSI-RS resource can be configured to one or more configuration methods based on information signaled from a higher layer in a transmission mode (e.g., TM 10) transmitted by a plurality of TPs. The CSI-IM resource can be resources to which a zero-power CSI-RS is mapped. The CSI-IM resource can be configured based on information signaled from a higher layer in a transmission mode (e.g., TM 10) transmitted by a plurality of TPs. Furthermore, if a case where a transmission mode is transmitted by a plurality of TPs is supported, a CSI-RS resource and a CSI-IM resource can be configured based on one or more configuration methods and a CSI process with UE can be performed based on the configured CSI-RS resource and CSI-IM resource.

In a CSI process, a plurality of TPs can send reference signals to UE based on a CSI-RS resource and a CSI-IM resource generated in accordance with different configuration methods. The UE can generate CSI feedback information based on the received CSI-RS resource and CSI-IM resource and send the generated CSI feedback information to the TPs. The CSI feedback information transmitted from the UE to the TPs can be information generated based on CSI process configuration information transmitted from a higher layer to the UE. Furthermore, as described above, a higher layer may send information about whether or not PMI/RI reporting is performed to UE as the CSI feedback information through a feedback information parameter, such as a pmi-RI-report parameter.

The CSI process configuration information transmitted by a higher layer can include, for example, information about an antenna port that sends a CSI-RS, reference PDSCH transmission power Pc (=a ratio of PDSCH EPRE to CSI-RS EPRE), and configuration information about a CSI-RS resource and a CSI-IM resource.

UE may use a different reference signal in order to perform CSI feedback depending on a transmission mode of a BS. For example, if a transmission mode of a BS is 10, UE may use a CSI-RS as a reference signal for CSI feedback. If the transmission mode of a BS is not 10, UE may use a CRS as a reference signal for CSI feedback.

Hereinafter, in an embodiment of the present invention, an assumption that UE generates CSI feedback information is disclosed, assuming that a plurality of TPs performs a CoMP based on subframes (or subcarriers) having different configurations and sends downlink data to the UE. That is, the assumption and/or determination of UE for obtaining CSI feedback information (e.g., a CQI index) based on a CSI reference resource are disclosed.

1. A case where a plurality of downlink TPs performs a CoMP based on a legacy subframe and UE does not report a PMI/RI as CSI feedback

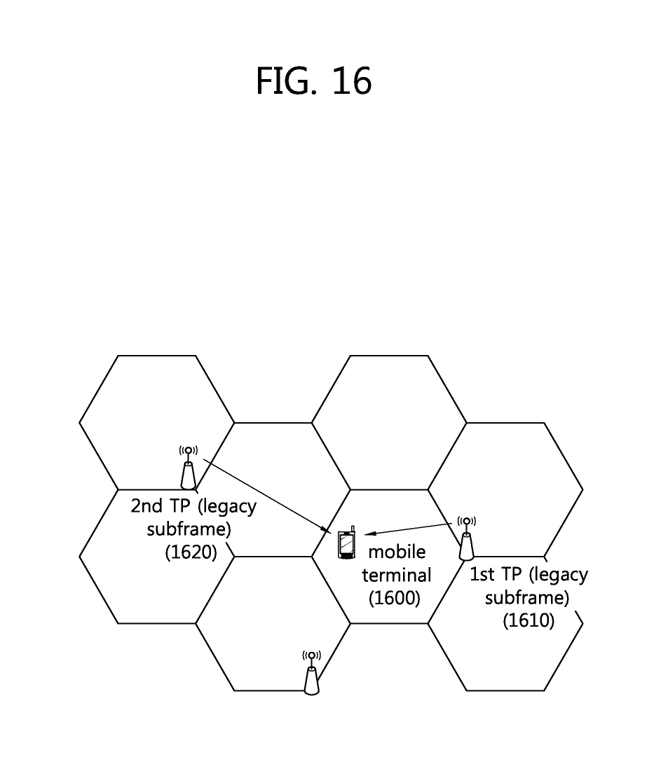

FIG. 16 is a conceptual diagram illustrating a case where a plurality of downlink TPs performs a CoMP based on a legacy subframe in accordance with an embodiment of the present invention.

UE 1600 can perform CSI feedback on which a PMI/RI are not reported according to the configuration of a higher layer. In this case, the UE 1600 can perform an assumption for a PDSCH transmission method based on information about an antenna port through which a CSI-RS is transmitted.

First, a case where the UE 1600 performs CSI feedback using a CRS as described above is disclosed below.

(1) A case where the UE 1600 performs CSI feedback using a CRS

The UE 1600 can perform CSI feedback using a CRS based on information (e.g., the number of CRS ports, a cell ID, and a v-shift) related to the CRS transmitted by each of TPs 1610 and 1620. The UE 1600 can assume a PDSCH transmission method, transmitted through a downlink channel, as follows based on the number of antenna ports of a CRS used by each of the TPs 1610 and 1620 participating in a CoMP.

1) When the number of antenna ports of the CRS is 1: PDSCH transmission using a single antenna port

2) When the number of antenna ports of the CRS is 2 or 4: PDSCH transmission using transmit diversity

If the UE 1600 performs CSI feedback using a CSI-RS, the UE 1600 can assume as follows.

(2) A case where the UE 1600 performs CSI feedback using a CSI-RS

The UE 1600 can perform CSI feedback based on CSI-RS configuration information transmitted by each of the TPs 1610 and 1620 participating in a CoMP. The CSI-RS configuration information can include configuration information about a zero-power CSI-RS and a non-zero-power CSI-RS. The UE 1600 can assume a PDSCH transmission method as follows depending on the number of antenna ports of the CSI-RS.

1) When the number of antenna ports of the CSI-RS is 1: PDSCH transmission using a single antenna port

2) When the number of antenna ports of the CSI-RS is 2 or 4: PDSCH transmission using transmit diversity

When the number of antenna ports of the CSI-RS is 8, an assumption or determination for the transmission of a PDSCH by the UE 1600 may not be defined. That is, if the UE 1600 performs CSI feedback not including PMI/RI reporting, each of the TPs 1610 and 1620 can limit the number of antenna ports of a CSI-RS to 4 or less. Or, the UE 1600 can operate only assuming the configuration of the 4 or less CSI-RS antenna ports. That is, in accordance with an embodiment of the present invention, the UE 1600 does not assume a case where the number of antenna ports related to a CSI-RS resource is configured to exceed 4 if a PMI/RI are not configured in a CSI process in a transmission mode that supports a CoMP.

That is, in accordance with an embodiment of the present invention, if a PMI/RI are not configured in a CSI process in a transmission mode that supports a CoMP, the UE 1600 can operate assuming that a PDSCH based on 8 antenna ports is not transmitted. In this case, if the number of antenna ports configured in a CSI-RS is 8, the UE 1600 can assume that PDSCH data is transmitted through four antenna ports (e.g., antenna ports 0, 1, 2, and 3) to feedback CSI. The UE 1600 can estimate channel information, obtained based on antenna ports (e.g., antenna ports 15, 16, 17, and 18) through which a CSI-RS is transmitted, as channel information about the antenna ports 0, 1, 2, and 3 and use the estimated channel information. The UE 1600 can neglect information that is transmitted through the remaining 4 antenna ports other than the antenna ports 15, 16, 17, and 18.

For another example, if a PMI/RI are not configured in a CSI process in a transmission mode supporting a CoMP, each of the TPs 1610 and 1620 can configure the number of antenna ports of a CSI-RS so that the number of antenna ports does not exceed 4 and perform transmission.

In the CSI process, CSI feedback can be transmitted by each of the TPs 1610 and 1620. The CSI feedback transmitted by each of the TPs 1610 and 1620 can include information, such as a cell ID, a TP index, and a CSI-RS resource index. As described above, the CSI feedback can be transmitted as a TP set including downlink TPs. That is, the UE 1600 can send the CSI feedback as a set of a plurality of other TPs including the downlink TPs 1610 and 1620.

Hereinafter, in an embodiment of the present invention, a case where the UE 1600 performs CSI feedback using a CSI-RS, such as (2), is disclosed in more detail. As described above, the UE 1600 may not send information about a PMI/RI when performing CSI feedback according to the configuration of a higher layer. That is, when performing a CSI process, the UE 1600 can determine whether or not to send a PMI/RI to the TPs 1610 and 1620 based on a feedback information parameter received from a higher layer. In accordance with an embodiment of the present invention, the UE 1600 can perform another assumption or determination on the transmission of a PDSCH depending on whether or not PMI/RI information is included as CSI feedback information. Hereinafter, in an embodiment of the present invention, a method by which the UE 1600 determines or assumes a PDSCH transmission method for a CSI feedback depending on whether or not PMI/RI information is included is disclosed.

(1) A case where a PMI/RI are not configured in a CSI process in a transmission mode supporting a CoMP

(1)-1. If the number of antenna ports related to a CSI-RS resource is one, the UE 1600 can determine that a PDSCH is transmitted through one antenna port (e.g., antenna port 7). Information about the channel of the antenna port 7 can be estimated from information about the channel of the antenna port (e.g., antenna port 15) of a CSI-RS resource related to the antenna port 7.

(1)-2. If the number of antenna ports related to a CSI-RS resource is two, the UE 1600 can assume or determine that a PDSCH is transmitted through two antenna ports (e.g., antenna ports 0 and 1) based on transmit diversity to feedback CSI. Information about the channel of each of the antenna ports 0 and 1 can be estimated from information about each of the channels of the antenna ports (e.g., antenna ports 15 and 16) of CSI-RS resources related to the antenna ports 0 and 1.

(1)-3. If the number of antenna ports related to a CSI-RS resource is four, the UE 1600 can assume that a PDSCH is transmitted through four antenna ports (e.g., antenna ports 0, 1, 2, and 3) based on transmit diversity to feedback CSI. Information about the channel of each of the antenna ports 0, 1, 2, and 3 can be estimated from information about each of the channels of the antenna ports (e.g., antenna ports 15, 16, 17 and 18) of CSI-RS resources related to the antenna ports 0, 1, 2, and 3.

In accordance with an embodiment of the present invention, if a PMI/RI are not configured in a CSI process in a transmission mode supporting a CoMP as described above, the UE 1600 does not assume a case where the number of antenna ports related to a CSI-RS resource exceeds 4. That is, if a PMI/RI are not configured in a CSI process in a transmission mode supporting a CoMP, the UE 1600 can operate without assuming the transmission of a PDSCH based on eight antenna ports.

Furthermore, in accordance with an embodiment of the present invention, the UE 1600 can determine the number of antenna ports of a CRS, configured in the downlink TP 1610, 1620, based on the number of antenna ports of a CSI-RS. For example, the UE 1600 can assume that the number of antenna ports of a CSI-RS configured in the downlink TP 1610, 1620 is the same as the number of antenna ports of a CRS configured in the downlink TP 1610, 1620. The number of antenna ports of the CRS that can be used in each of the downlink TPs 1610 and 1620 can be different. The UE 1600 can obtain information about the antenna ports of a CRS based on the number of antenna ports through which a CSI-RS is transmitted although information about the antenna ports of the CRS used by each of the TPs 1610 and 1620 is separately not received because the UE 1600 assumes or determines that the number of antenna ports of the CSI-RS is the same as the number of antenna ports of the CRS used by each of the TPs 1610 and 1620.

(2) A case where a PMI/RI are configured in a CSI process in a transmission mode supporting a CoMP

If a PMI/RI are configured in a CSI process in a transmission mode supporting a CoMP, a PDSCH can be transmitted based on an antenna port {15 . . . 14+P} configured in a CSI-RS resource. Here, ‘P’ can be any one of values 1, 2, 4, and 8 depending on the number of antenna ports configured as a CSI-RS. If a PMI/RI are configured in a CSI process in a transmission mode supporting a CoMP, unlike in the case where a PMI/RI are not configured, the UE 1600 can assume a case where the number of antenna ports related to a CSI-RS resource has been set to 8. That is, the UE 1600 can differently determine or assume the number of antenna ports configured in relation to a CSI-RS resource depending on whether a PMI/RI have been configured or not in a CSI process in a transmission mode supporting a CoMP.

2. A case where a plurality of downlink TPs performs a CoMP based on a legacy subframe and a subframe through which a CRS is not transmitted and UE does not report a PMI/RI as CSI feedback

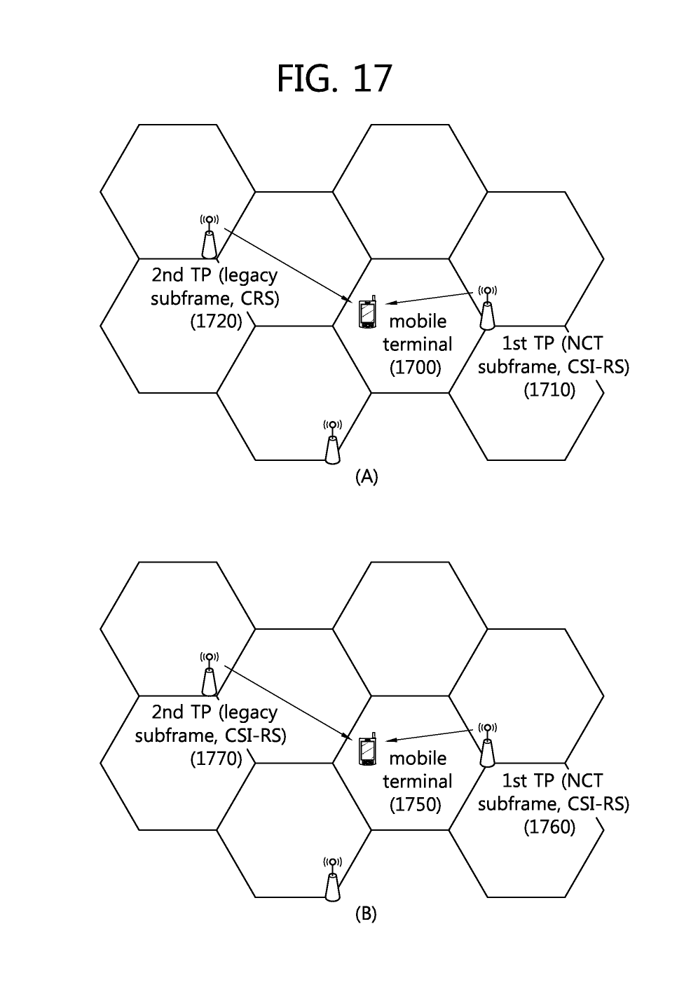

FIG. 17 is a conceptual diagram showing a case where a plurality of downlink TPs performs a CoMP based on a legacy subframe and an NCT subframe in accordance with an embodiment of the present invention.

In FIG. 17, a subframe through which a CRS is not transmitted may mean an NCT subframe. In FIG. 17(A), a case where a CSI-RS is transmitted through a legacy subframe and a case where a CSI-RS is not transmitted through a legacy subframe are assumed. Hereinafter, in an embodiment of the present invention, it is assumed that a subframe through which a CRS is not transmitted is an NCT subframe, for convenience of description.

(1) A case where UE 1700 performs CSI feedback based on a CSI-RS transmitted through an NCT subframe and a CRS transmitted through a legacy subframe

FIG. 17(A) shows a case where a first TP 1710 sends an NCT subframe including a CSI-RS and a second TP 1720 sends a legacy subframe including a CRS. FIG. 17(A) assumes a transmission mode that a legacy subframe does not include CSI-RS.

The UE 1700 can perform CSI feedback to each of the first and the second TPs 1710 and 1720 based on a CRS transmitted through a legacy subframe and a CSI-RS transmitted through an NCT subframe. The UE 1700 can perform CSI feedback based on information related to the CRS of the legacy subframe and information related to the CSI-RS of the NCT subframe. The UE 1700 can assume or determine the transmission of a PDSCH as follows based on the CRS transmitted through the legacy subframe and the CSI-RS transmitted through the NCT subframe.

1) An assumption of PDSCH transmission in a legacy subframe

1)-1. When the number of antenna ports of an CRS is 1: PDSCH transmission using a single antenna port

1)-2. When the number of antenna ports of an CRS is 2 or 4: PDSCH transmission based on transmit diversity

2) An assumption of PDSCH transmission in an NCT subframe

2)-1. When the number of antenna ports of a CSI-RS is 1: PDSCH transmission using a single antenna port

2)-2 When the number of antenna ports of a CSI-RS is 2 or 4: PDSCH transmission based on transmit diversity

If the number of antenna ports of a CSI-RS is 8, the assumption or determination of the UE 1700 regarding the transmission of a PDSCH may not be defined. That is, if the UE 1700 performs CSI feedback without PMI/RI reporting, each of the TPs 1710 and 1720 can configure the number of antenna ports of a CSI-RS so that the number of antenna ports of the CSI-RS is 4 or less. Or, the UE 1700 can operate only assuming a configuration in which the number of antenna ports of a CSI-RS is 4 or less. That is, in accordance with an embodiment of the present invention, if a PMI/RI are not configured in a CSI process in a transmission mode supporting a CoMP, the UE 1700 does not assume a case where the number of antenna ports related to a CSI-RS resource is configured to exceed 4. For example, each of the TPs 1710 and 1720 can configure the number of antenna ports of a CSI-RS so that the number of antenna ports of the CSI-RS is limited to 4 or less. Or, the UE 1700 can operate only assuming a configuration in which the number of antenna ports of a CSI-RS is 4 or less.

When performing CSI feedback using a CRS transmitted through a legacy subframe and performing CSI feedback using a CSI-RS transmitted through an NCT subframe, the UE 1700 can perform a different assumption and determination in order to generate CSI feedback information. That is, a definition of a CSI reference resource for generating CSI feedback information can be different depending on a channel and signal included in a subframe. For example, unlike in a legacy subframe, in an NCT subframe, a CRS and PDCCH may not be defined. In this case, the UE 1700 can regard a resource region, allocated to a PDCCH, as a CSI reference resource without regarding a CRS as a CSI reference resource in order to generate CSI feedback information.

For example, if a subframe transmitted by a TP is a legacy subframe, in relation to CSI feedback to the TP, CSI feedback information (e.g., CQI) can be obtained assuming a CSI reference resource excluding a CRS and PDCCH. In contrast, when CSI feedback for an NCT subframe transmitted by a TP is obtained, a CQI is calculated assuming a CSI reference resource without overhead, such as a CRS/PDCCH. This method is one example of a method of generating CSI feedback. In this method, a CQI may be obtained by taking only a CSI reference resource, corresponding to a legacy subframe and an NCT subframe in common, into consideration.

(2) A case where UE 1750 performs CSI feedback based on CSI-RSs transmitted through an NCT subframe and a legacy subframe

FIG. 17(B) shows a case where a first TP 1760 sends an NCT subframe including a CSI-RS and a second TP 1770 sends a legacy subframe including a CSI-RS.

If a CSI-RS is supported in a legacy subframe, the UE 1750 can perform CSI feedback based on CSI-RSs transmitted through an NCT subframe and a legacy subframe. The UE 1750 can perform CSI feedback based on information related to the CSI-RSs transmitted through the NCT subframe and the legacy subframe. The UE 1750 can assume or determine the transmission of a PDSCH as follows based on the CSI-RSs transmitted through the legacy subframe and the NCT subframe, respectively.

1) An assumption for PDSCH transmission in an NCT subframe and a legacy subframe

1)-1. When the number of antenna ports of a CSI-RS is 1: PDSCH transmission using a single antenna port

1)-2. When the number of antenna ports of a CSI-RS is 2 or 4: PDSCH transmission based on transmit diversity

In a CSI process, CSI feedback can be transmitted by each of the first and the second TPs 1760 and 1770. The CSI feedback transmitted by each of the first and the second TPs 1760 and 1770 can include information, such as a cell ID, a TP index, and a CSI-RS resource index. As described above, the CSI feedback can be transmitted as a TP set including the downlink TPs 1760 and 1770. That is, the UE 1750 can send the CSI feedback as a set of a plurality of other TPs including the downlink TPs 1760 and 1770.

Likewise, if the number of antenna ports of a CSI-RS is 8, an assumption or determination for the transmission of a PDSCH by the UE 1750 may not be defined. That is, if the UE 1750 performs CSI feedback without PMI/RI reporting, each of the TPs 1760 and 1770 can configure the number of antenna ports of a CSI-RS by limiting the number of antenna ports of the CSI-RS to 4 or less. Or, the UE 1750 can operate only assuming a configuration in which the number of antenna ports of a CSI-RS is 4 or less.

According to an another embodiment of the present invention, a UE may not perceive whether a plurality of TPs transmit different kind of subframes when the TPs perform CoMP to transmit downlink subframe like a TP transmitting a legacy subframe and a TP transmitting an NCT subframe. In this case, the UE can feedback a CSI by assuming a downlink subframe as a legacy subframe or an NCT subframe. For example, the UE assumes a downlink subframe as a legacy subframe to feedback CSI. For another example, the UE assumes a downlink subframe as an NCT subframe to feedback CSI. Whether a UE assumes a downlink subframe as an NCT subframe or a legacy subframe can be transmitted to the UE by a higher layer signalling.

According to an another embodiment of the present invention, A UE can determine CSI by assuming a downlink subframe as an overhead of a legacy subframe or an overhead of an NCT subframe based on a signaling information of higher layer. In short, When the UE receives an NCT subframe and a legacy subframe by CoMP, an NCT subframe and a legacy subframe can be classified based on a CSI resource configuration index. The UE can perceive downlink subframe as a legacy subframe or an NCT subframe. The UE assumes an overhead of an NCT subframe to determine CSI if the UE perceive downlink subframe as an NCT subframe and the UE assumes an overhead of a legacy subframe to determine CSI if the UE perceive downlink subframe as a legacy subframe.

3. A case where a plurality of downlink TPs performs a CoMP based on a subframe through which a CRS is not transmitted and UE does not report a PMI/RI as CSI feedback

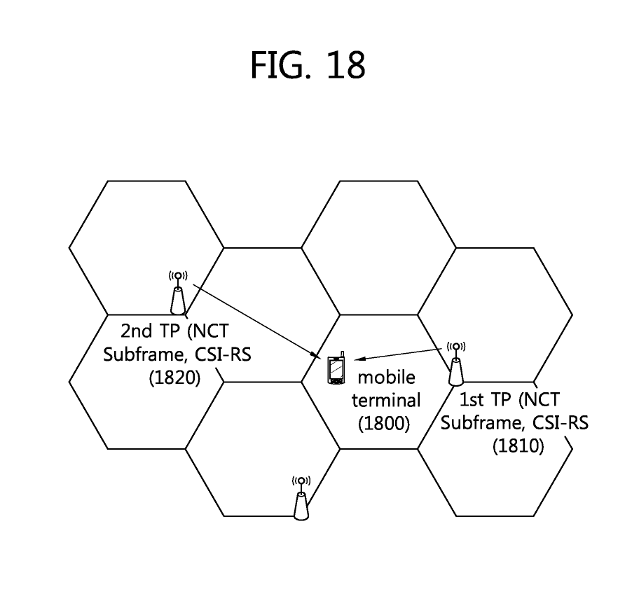

FIG. 18 is a conceptual diagram showing a case where a plurality of downlink TPs performs a CoMP based on an NCT subframe in accordance with an embodiment of the present invention.

In FIG. 18, a subframe through which a CRS is not transmitted may mean the above-described NCT subframe. Hereinafter, in an embodiment of the present invention, it is assumed that a subframe through which a CRS is not transmitted is an NCT subframe, for convenience of description.

UE 1800 can generate CSI feedback information based on a CSI-RS received through each NCT subframe. The UE 1800 can perform an assumption or determination for the transmission of a PDSCH that is performed based on a CSI-RS transmitted through an NCT subframe.

1) An assumption for PDSCH transmission in an NCT subframe

1) When the number of antenna ports of a CSI-RS is 1: PDSCH transmission using a single antenna port

2) When the number of antenna ports of a CSI-RS is 2 or 4: PDSCH transmission based on transmit diversity

Likewise, in a CSI process, CSI feedback can be transmitted by each TPs 1810 and 1820. The CSI feedback transmitted by each of the TPs 1810 and 1820 can include information, such as a cell ID, a TP index, and a CSI-RS resource index. As described above, the CSI feedback can be transmitted as a TP set including downlink TPs. That is, the UE 1800 can transmit the CSI feedback as a set of a plurality of other TPs including the downlink TPs 1810 and 1820.

Likewise, when the number of antenna ports of a CSI-RS is 8, an assumption or determination for the transmission of a PDSCH by the UE 1800 may not be defined. That is, when the UE 1800 performs CSI feedback without PMI/RI reporting, the TPs 1810 and 1820 can configure the number of antenna ports of a CSI-RS by limiting the number of antenna ports of the CSI-RS to 4 or less. Or, the UE 1800 can operate assuming a configuration in which the number of antenna ports of the CSI-RS is 4 or less.

Hereinafter, in an embodiment of the present invention, a method of configuring a CSI process when UE performs CSI feedback based on a legacy subframe through which a plurality of downlink TPs sends a CRS using a CoMP and a subframe (e.g., NCT subframe) through which a plurality of downlink TPs does not send a CRS is disclosed below.

A CSI process can be configured so that different CSI feedback is performed between UE and each TP because a channel environment is different between the TP and the UE. A configuration for a CSI process can be different every UE in order to take various types of interference environments into consideration. UE can perform CSI feedback based on CSI process configuration information that is received from a higher layer. The CSI process configuration information transmitted from a higher layer to the UE can include information, such as the number of antenna ports of a CSI-RS, reference PDSCH transmission power Pc (=a ratio of PDSCH EPRE to CSI-RS EPRE), and a CSI reference resource indication value.

The number of antenna ports of a CSI-RS can indicate the number of antenna ports of a CSI-RS in which a CSI-RS resource has been configured. ‘Pc’ indicates reference PDSCH transmission power for each CSI-RS resource. The CSI reference information indication can indicate CSI reference information that is used for UE to perform CSI feedback. This CSI configuration information can be transmitted by each UE. Some or all of the pieces of CSI configuration information can be cells-specific information that is applied within a CoMP set in common. In this case, the CSI configuration information may be configured to have the same value.

In accordance with an embodiment of the present invention, a CSI reference resource can be differently configured in each CSI-RS process. In this case, signaling regarding a CSI reference resource for each CSI-RS process can be transmitted to UE, so that the UE can obtain information about the CSI reference resource for obtaining CSI feedback information.

As described above, a CSI reference resource for CSI feedback can be different in a legacy subframe and an NCT subframe. For example, in a legacy subframe, a PDCCH can be transmitted in the former 3 OFDM symbols of the legacy subframe, and a CRS can be allocated to different resources according to an index of an antenna port and transmitted. In the legacy subframe, resources allocated to a PDCCH and a CRS can be taken into consideration in order to obtain a CSI reference resource. In contrast, in the case of an NCT subframe, a PDCCH and a CRS may not be taken into consideration in order to obtain a CSI reference resource because the CRS or the PDCCH is not transmitted.

If a CRS is taken into consideration in order to obtain CSI feedback information, CSI process configuration information transmitted by a higher layer can additionally include information about the number of antenna ports of a CRS. For another example, when UE receives data through a CoMP based on a legacy carrier and a carrier through which a CRS is not transmitted, a BS can send information about the configuration and/or construction of a CSI reference resource to the UE for each CSI-RS process. In order to obtain CSI feedback information for each CSI-RS process, signaling including configuration information about a CSI reference resource can be defined as CSI reference resource indication. The signaling for the CSI reference resource indication can be semi-statically transmitted from the BS to the UE.

For example, UE can derive CSI feedback information, assuming that a PDCCH is transmitted in the former 3 OFDM symbols of a legacy subframe and transmitted depending on an antenna port in which a CRS has been configured in a CSI-RS process for a TP that sends the legacy subframe. Furthermore, if an NCT subframe is transmitted by a TP, UE can derive CSI feedback information assuming that a CRS and a PDCCH are not transmitted in the NCT subframe. In this case, the UE can derive the CSI feedback information using a corresponding resource as a CSI reference resource, assuming that the PDSCH is transmitted from the first OFDM symbol of the NCT subframe.

For another example, UE can derive CSI feedback information, assuming that a CSI reference resource is the same as the CSI reference resource of a legacy subframe by not taking whether a subframe transmitted by a TP is the legacy subframe or an NCT subframe into consideration. That is, assuming that downlink control data corresponding to the former 3 OFDM symbols of the legacy subframe is always transmitted and a CRS is transmitted based on information about the configuration of antenna ports, the UE can determine a CSI reference resource for CSI feedback and derive the CSI feedback information. In order to take a CRS into consideration, information about the antenna ports of the CRS can be included in the CSI-RS process configuration information.

For yet another example, UE can derive CSI feedback information assuming that a CSI reference resource is the same as the CSI reference resource of an NCT subframe by not taking whether a subframe transmitted by a TP is the legacy subframe or an NCT subframe into consideration. In this case, the UE can derive the CSI feedback information by not taking resources allocated to a downlink control channel and resources allocated to a CRS into consideration.

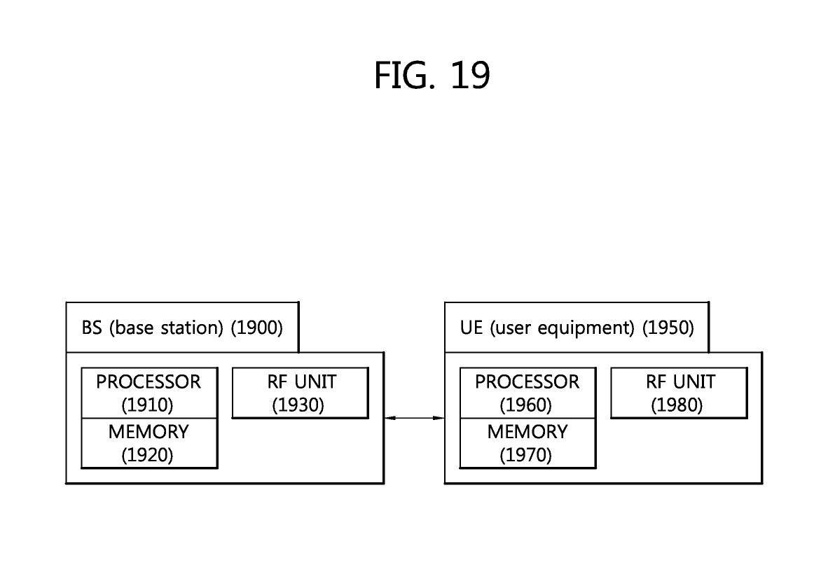

FIG. 19 is a block diagram showing a wireless communication system in accordance with an embodiment of the present invention.

Referring to FIG. 19, a BS 1900 includes a processor 1910, a memory 1920, and a Radio Frequency (RF) unit 1930. The memory 1920 is connected to the processor 1910 and configured to store various pieces of information for driving the processor 1910. The RF unit 1920 is connected to the processor 1910 and configured to transmit and/or receive radio signals. The processor 1910 implements the proposed functions, processes, and/or methods. In the above-described embodiments, the operation of the BS can be implemented by the processor 1910.

For example, the processor 1910 can differently configure the channel and signal of a subframe by taking the configuration of an NCT subframe and a legacy subframe transmitted by another cell into consideration.

A wireless device 1950 includes a processor 1960, a memory 1970, and an RF unit 1980. The memory 1970 is connected to the processor 1960 and configured to store various pieces of information for driving the processor 1960. The RF unit 1980 is connected to the processor 1960 and configured to transmit and/or receive radio signals. The processor 1960 implements the proposed functions, processes, and/or methods. In the above-described embodiments, the operation of the wireless device can be implemented by the processor 1960.

For example, the processor 1960 can receive channel data and signals transmitted by a plurality of cells by taking the configuration of an NCT subframe and a legacy subframe transmitted by another cell into consideration.

The processor can include Application-Specific Integrated Circuits (ASICs), other chipsets, logic circuits and/or data processors. The memory can include Read-Only Memory (ROM), Random Access Memory (RAM), flash memory, memory cards, storage media and/or other storage devices. The RF unit can include a baseband circuit for processing radio signals. When the embodiment is implemented in software, the above-described scheme can be implemented into a module (or process or function) configured to perform the above functions. The module can be stored in the memory and executed by the processor. The memory can be placed inside or outside the processor and can be connected to the processor using a variety of well-known means

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The capabilities of UE can be improved.

What is claimed is:

1. A method of a channel state information (CSI) feedback of a mobile terminal, the method comprising:
receiving, by the mobile terminal, a CSI feedback configuration configuring a CSI feedback reporting to a base station without precoding matrix index (PMI) and rank index (RI);
receiving, by the mobile terminal, a CSI configuration for a channel state information reference signal (CSI-RS);
determining, by the mobile terminal, a physical downlink share channel (PDSCH) transmission scheme based on an antenna port of the CSI-RS;
determining, by the mobile terminal, a CSI based on the PDSCH transmission scheme; and
transmitting, by the mobile terminal, the CSI to the base station,
wherein the PDSCH transmission scheme is a transmission scheme based on a single-antenna port when a number of the antenna port of the CSI-RS is one,
wherein the PDSCH transmission scheme is a transmission scheme based on a transmission diversity when the number of the antenna port of the CSI-RS is two or four, and
wherein the number of the antenna port of the CSI-RS is less than or equal to 4.

2. The method of claim 1, further comprising:
receiving the CRS (cell-specific reference signal),
wherein the number of the antenna port of the CSI-RS is equal to the number of the antenna port of the CRS.

3. The method of claim 2, further comprising
determining, by the mobile terminal, resource allocation information used to derive the CSI.

4. The method of claim 1,
wherein the CSI configuration includes the number of the antenna port of the CSI-RS as information element.

5. The method of claim 1,
wherein the number of the antenna port of the CSI-RS is 1, 2, 4 or 8 when the CSI feedback configuration configuring the CSI feedback with PMI/RI is received.

6. A wireless device in a wireless communication system, the wireless device comprising:
a processor configured to receive a CSI feedback configuration configuring a CSI feedback reporting to a base station without precoding matrix index (PMI) and rank index (RI),
receive a CSI configuration for a channel state information reference signal (CSI-RS),
determine a physical downlink share channel (PDSCH) transmission scheme based on an antenna port of the CSI-RS,
determine a CSI based on the PDSCH transmission scheme, and
transmit the CSI to the base station,
wherein the PDSCH transmission scheme is a transmission scheme based on a single-antenna port when a number of the antenna port of the CSI-RS is one,
wherein the PDSCH transmission scheme is a transmission scheme based on a transmission diversity when the number of the antenna port of the CSI-RS is two or four, and
wherein the number of the antenna port of the CSI-RS is less than or equal to 4.

7. The wireless device of claim 6,
the processor further configured to receiving the CRS (cell-specific reference signal),
wherein the number of the antenna port of the CSI-RS is equal to the number of the antenna port of the CRS.

8. The wireless device of claim 7,
the processor further configured to determine resource allocation information used to derive the CSI.

9. The wireless device of claim 6,
wherein the CSI configuration includes the number of the antenna port of the CSI-RS as information element.

10. The wireless device of claim 6,
wherein the number of the antenna port of the CSI-RS is 1, 2, 4 or 8 when the CSI feedback configuration configuring the CSI feedback with PMI/RI is received.
